(19) United States
(12) Patent Application Publication
(10) Pub. No.: US 2012/0038273 A1
(43) Pub. Date: Feb. 16, 2012

(54) Fluorescent illumination device

(76) Inventor: Frederick Elvin, Oakland, MI (US)

(21) Appl. No.: 13/135,835

(22) Filed: Jul. 15, 2011

Related U.S. Application Data
(60) Provisional application No. 61/400,646, filed on Jul. 30, 2010.

(51) Int. Cl. H01J 61/56; H01J 61/36

(52) U.S. Cl. 315/51; 313/623

(57) ABSTRACT

An illumination device having an elongate bulb and an outer casing substantially coextensive with the bulb and surrounding the same. The elongated bulb is a CCFL which generally has a glass bead containing an iron electrode embedded in the center and attached to both ends thus sealing the elongate bulb. The end of the CCFL bulb will have the iron electrode bent over and in contact with an outside surface of the bulb and then have a coil spring connector arranged over the end of the bulb. The coil spring connector contacts the iron electrode thus allowing for electricity to flow through the coil spring connector to the iron electrode and the associated electronic circuitry needed to operate the CCFL bulb.

This application claims benefit of U.S. Provisional Patent Application 61/400,646 filed Jul. 30, 2010

### BACKGROUND OF THE INVENTION

1. Field of the Invention

The present invention generally relates to illumination devices, and relates more particularly to an improved device having a cold cathode fluorescent light in a small compact lightweight housing that is capable for numerous uses in rotational applications and with tapered spring connectors arranged on each end thereof.

2. Description of Related Art

Fluorescent lights have long been known in the art, and have in recent years received significant attention due to their relatively low power consumption- and low heat output. Fluorescent lamps are used to provide illumination in typical electrical devices for general lighting purposes because they are more efficient than incandescent bulbs in producing light. A fluorescent lamp is a low pressure gas discharge source, in which light is produced predominately by fluorescent powders activated by ultraviolet energy generated by mercury plasma forming an arc. The lamp, usually in the form of a tubular bulb with an electrode sealed into each end, contains mercury vapor at low pressure with a small amount of inert gas for starting. The inner walls of the bulb are coated with fluorescent powders commonly called phosphors. When the proper voltage is applied, the plasma forming an arc is produced by current flowing between the electrodes through the mercury vapor. This discharge generates some visible radiation and excitation of mercury atoms causes it to emit ultraviolet light. The ultraviolet light in turn excites the phosphors to emit light.

Two electrodes are hermetically sealed into the bulb, one at each end. These electrodes are designed for operating as either “cold” or “hot” cathodes or electrodes, more correctly called glow or arc modes of discharge operation. Electrodes for glow or cold cathode operation may consist of closed end metal cylinders, generally coated on the inside with an emissive material. “Cold” refers to electrodes that do not rely on additional means of harmonic emission besides that created by the electrical discharge through the tube. It also refers to the lack of a filament, and only one electrode at each end. In contrast, hot cathode fluorescents include an electrode in the form of a filament, heated with current passing there through, which provides enhanced emissions from the lamp. Hot also refers to two electrodes at each end and a filament therebetween, which warms the mercury.

Conventional fluorescent lamps operate at a predetermined current with a high cathode fall or voltage drop. CCFL's are not appreciably affected by starting frequency because of the type of electrode used. CCFL's emit light in the same way as do standard hot electrode lamps. In general, the latter type operates as normal glow discharges and their electrodes maybe uncoated hollow or solid cylinders of nickel or iron.

The cathode fall is high and to obtain high efficacy or power for general lighting purposes, conventional lamps may have any length, with any known diameter. The advantages of CCFL's compared with the hot electrode fluorescent lamps are that they typically have a very long life, in consequence of their rugged electrodes, lack of filament and low current consumption. They are able to start fairly quickly, even under cold ambient conditions. Their life is less affected by the number of starts. Also, they may be dimmed to relatively low levels of light output. Generally, with CCFL's a strike or start voltage is twice as high as a run voltage.

However, some prior art CCFL's may have reduced life because of metal fatigue on the single strand iron electrode extending from the end thereof. Hence, there is a need in the art for an improved engagement between the lamp and electrode creating a secured physical and electrical contact between the electrode of the CCFL and the lamp to in which it is arranged. There also is a need in the art for an improved spring connector to be attached to the end of the glass bulb of the CCFL. There also is a need in the art for an improved tubular part holder for stabilization of a longitudinal device within the CCFL tube in relation to the other parts. There also is a need in the art for a tubular fixture that will independently be able to rotate a light tube fixture into a predetermined position. There also is the need in the art for hermetically sealed light fixtures that hold CCFL tubes in predetermined positions and have predetermined shape reflectors to optimize light emitting from the fixture so that the fixture can be used in flat conical shape reflectors, with multiple bulbs, within cantilevered fixtures, on the frame of rectangular or other shaped frames, in overhead fans, in standard residential ceiling fixtures, or recessed fixtures and the like.

### SUMMARY OF THE INVENTION

An object of the present invention may be to provide a simple and compact lighting device, particularly well suited for mounting in the interior of a confined space such as a storage cabinet or any other lighting area.

A further object of the present invention may be to provide a simple and highly efficient design for a substantially water tight illumination device.

Yet a further object of the present invention may be to provide an adjustable illumination device.

Still a further object of the present invention may be to provide a coil spring connector for the end of a CCFL for use with the present invention.

Yet another object of the present invention may be to provide a tubular part holder for stabilization of a longitudinal device within a tube or glass container or other applications.

Yet another object of the present invention may be to provide a single or double lamp tube fixture that allows for two CCFL fixtures to each independently rotate to predetermined lighting positions.

Yet another object of the present invention may be to provide for safety and replacement improvements to the electrical contacts of the CCFL according to the present invention.

Still another object of the present invention may be to provide for a hermetically sealed CCFL for use in rectangular light fixtures or in other self contained sealed housing units.

Still another object of the present invention may be to provide a predetermined shaped reflector to optimize light fixture output for a CCFL according to the present invention.

Still another object of the present invention may be to provide for a CCFL for use in a flat or conical shape reflector, a cantilevered light fixture, a rectangular frame or other shaped frame, in a vent or other standard ceiling can fixture and the like.

In one aspect, the present invention provides an illumination device having an elongate bulb and an outer casing substantially coextensive with the bulb and surrounding the same. The CCFL elongate bulb generally has a glass bead containing an iron electrode embedded in the center and attached to both ends thus sealing the elongate bulb or tube. The end of the CCFL bulb or tube will have the iron electrode bent over into contact with an outside surface of the bulb and then have a coil spring connector arranged over the end of the bulb, such that the coil spring connector contacts the iron electrode, thus allowing for electricity to flow through the coil spring connector to the iron electrode and the associated electronic circuitry needed to operate the CCFL tube.

Other objects, features, and advantages of the present invention will become apparent from the subsequent description and appended claims, taken in conjunction with the accompanying drawings.

### BRIEF DESCRIPTION OF THE DRAWINGS

FIG. 1 shows a side view of a prior art CCFL bulb.

FIG. 2 shows a side view of a CCFL bulb.

FIG. 3 shows a prior art end view of a CCFL bulb.

FIG. 4 shows a CCFL bulb end view prepared to receive a conductive spring according to the present invention.

FIG. 5 shows a connector spring for use according to the present invention.

FIG. 6 shows a connector spring according to the present invention.

FIG. 7 shows a CCFL bulb and connector spring according to the present invention.

FIG. 8 shows an alternate embodiment of the CCFL bulb and connector spring according to the present invention.

FIG. 9 shows a side view of a bulb clamping device according to the present invention.

FIG. 10 shows a side view of an alternate embodiment of a bulb clamping device according to the present invention.

FIG. 11 shows an alternate embodiment of a bulb clamping device according to the present invention.

FIGS. 12 A-C show an alternate embodiment of a bulb clamping device according to the present invention.

FIG. 13 shows a lamp tubular fixture according to the present invention.

FIG. 14 shows a partially exploded view of a lamp tubular fixture according to the present invention.

FIG. 15 shows a mounting circuit according to the present invention.

FIG. 16 shows a circuit diagram depicting a parasitic loss paths associated with the typical backlight circuit according to the present invention.

FIG. 17 shows a side view of a CCFL bulb mounted in a light tube according to the present invention.

FIG. 18 shows a cross sectional end view of a light tube and bulb according to the present invention.

FIG. 19 shows an end view of an illumination device according to the present invention.

FIG. 20 shows a plug in circuit board for a single and dual lamp light fixture according to the present invention.

FIG. 21 shows an end view of an illumination device according to the present invention.

FIG. 22 shows an end view of an illumination device with a porous mercury absorbent material arranged in an end thereof according to the present invention.

FIG. 23 shows an alternate embodiment of an illumination device according to the present invention.

FIG. 24 shows an end view of an alternate embodiment of an illumination device according to the present invention.

FIG. 25 shows rectangular light fixture according to the present invention.

FIG. 25b shows an alternate embodiment of an illumination device according to the present invention.

FIG. 25c shows an exploded view of an alternate embodiment of an illumination device according to the present invention.

FIG. 26 shows a rectangular light fixture according to the present invention.

FIG. 27 shows a square light fixture according to the present invention.

FIG. 27b shows an alternate embodiment of a square light fixture according to the present invention.

FIG. 28 shows a close up view of the square light fixture according to FIG. 27.

FIG. 28b shows a shape reflector optimized light fixture according to the present invention.

FIG. 29 shows an alternate embodiment of an electrical connector according to the present invention.

FIG. 30 shows a light fixture having a gasket arranged therebetween.

FIG. 31 shows an elongated light fixture according to the present invention.

FIG. 32 shows a low profile fixture according to the present invention.

FIG. 33 shows a low profile fixture according to the present invention.

FIG. 34 shows a cantilevered light fixture according to the present invention.

FIG. 35 shows a frame being lit by an illumination device according to the present invention.

FIG. 36 shows a light fixture for use in a standard residential or commercial ceiling can fixture according to the present invention.

FIG. 37 shows a light fixture for use in a standard residential or commercial ceiling can fixture according to the present invention.

FIG. 38 shows a lighting fixture for use in a recessed application according to the present invention.

FIG. 39 shows a rectangular lighting fixture according to the present invention.

FIG. 40 shows a stabilizer member for use in the fixture of FIG. 39.

FIG. 41 shows alternate embodiments of a stabilizer member for use in FIG. 39.

FIG. 42 shows yet another alternate embodiment of a stabilizer member for the fixture in FIG. 39.

FIG. 43 shows CCFL lamp fixtures according to the present invention.

FIG. 44 shows CCFL lamp fixtures according to the present invention.

FIG. 45 shows a disc member for use in a light fixture according to the present invention.

FIG. 46 shows a disc member and cylindrical member for use in an alternate embodiment of a light fixture according to the present invention.

FIG. 47 shows an end view of a light fixture according to an alternate embodiment of the present invention.

FIG. 48 shows an alternate embodiment of a light fixture according to the present invention.

### DESCRIPTION OF PREFERRED EMBODIMENT(S)

Referring to the drawings, there are shown various views and embodiments of a light fixture or illumination device according to the present invention. The illumination device generally includes a cold cathode fluorescent lamp (CCFL) in any of the light fixtures shown in the Figures, according to the present invention. The illumination device may be used in any known lighting application including but not limited to, recessed lights in commercial or residential buildings, existing light fixtures, as cabinet under lights, as back lighting, as lighting around mirrors, frames, and signs, or in any other known application that uses light to produce a desired effect for viewers. It should be noted that generally a CCFL bulb is used in the lighting and illumination devices of the present invention. However, some of the improvements for the illumination device may be used with other types of bulbs other than CCFL's.

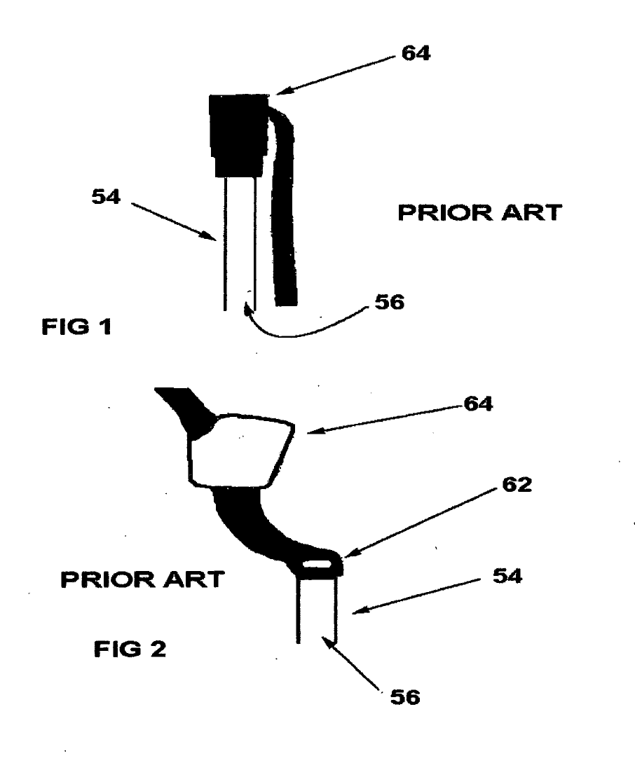

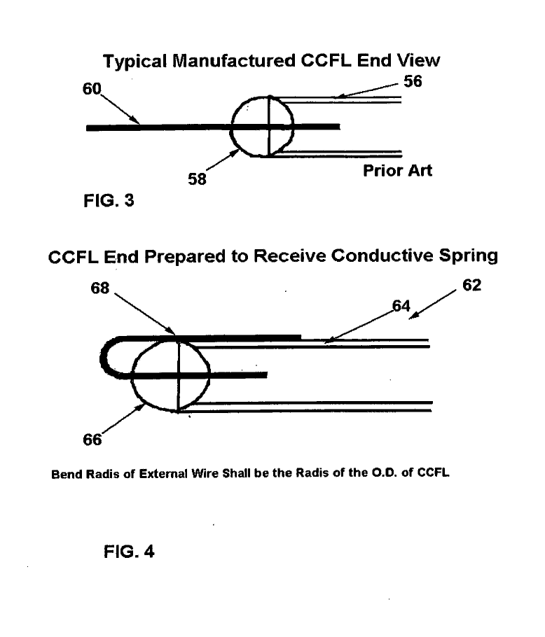

FIGS. 1 through 3 show a prior art CCFL 54. The CCFL 54 typically includes a bulb 56, which generally is made of a glass tube 56 with a glass bead 58 bonded thereto. An iron electrode 60 is embedded in the center of the glass bead 58. The glass bead 58 is bonded to both ends of the tube 56, thus sealing the tube 56 and creating the bulb for the CCFL 54. The electrode 60 is generally attached to a wire harness or to a fixed point 62. The electrode 60 generally is welded or soldered to a wire or other electrical system and then covered with an insulating cover 64 to protect the end of the CCFL 54 from damage and to protect users from electrical shock during use of the bulbs. It should be noted that the electrode 60 generally is made of a special iron alloy that will bond to glass. Furthermore, generally in the prior art when the wire is attached to the electrode 60 that extends out of the end of the CCFL 54, the electrode 60 generally is bent into a circular pattern to form a loop around the extension wire, which then will be crimped and then soldered to the extension wire to create the electrical circuit to allow for current and voltage to pass through the electrical wire and electrode 60 into the bulb 56 of the CCFL 54. However, in these prior art systems the process of forming a loop may put a strain on the iron glass bond, which may lead to a gas leak and cause the lamp to fail. Furthermore, the joint between the electrode 60 and the extension wire generally is a soldered joint. The process of soldering may cause thermal stress to be imparted to the glass bond which may result in a leak and CCFL failure. Also, when the external electrode 60 is attached to a fixed point, care must be taken for thermal or physical changes, generally a Z-bend was used in the electrode lead between the CCFL glass end and the end of the CCFL electrode 60, which may cause metal fatigue of the single strand iron electrode 60 extending from the end of the glass bead 58. The electrode wire 60 extending from the end of the lamp 62 may be shaped, formed or wound to form a spring 70 before the glass bead 58 is attached, after the bead is attached, or after the whole lamp is completely built.

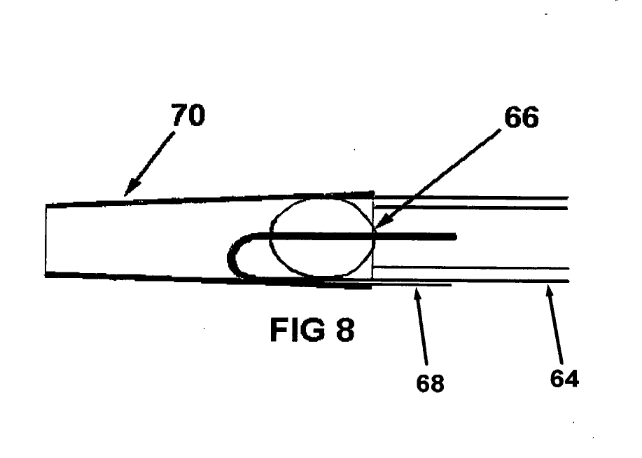

As shown in FIGS. 4 through 8, the present invention creates an improved CCFL 62 that generally includes a tube or bulb 64 that is generally made of a glass, however any other type of material may be used for the tube 64 depending on the design requirements and environment in which the CCFL 62 will be used. The CCFL 62 of the present invention also includes a glass bead 66 bonded to the glass tube 64 via any known bonding technique, wherein the glass bead 66 has an electrode 68 extending through a center portion thereof and extends a predetermined distance from at least one surface of the glass bead 66. In one embodiment the electrode 68 extends from the glass bead 66 from one surface arranged inside the tube 64 and also extends from one surface arranged outside the tube 64. It should be noted that the electrode 68 in the present embodiment is contemplated to be made of an iron material, however any other type of metal, ceramic, natural material, plastic, composite, or the like may be used for the material to make the electrode 68 of the CCFL 62. The portion of the electrode 68 that extends outside of the tube 64 of the CCFL 62 of the present invention may be bent back over onto the lamp tube 64 such that a portion of the electrode 68 is in contact with an outer surface of the lamp tube 64 at a predetermined position. A tapered coiled spring 70 may be arranged over the end of the bulb 64 and electrode 68 such that the inside surface of the tapered coil spring 70 is in contact with the electrode 68, while the electrode 68 is also in contact with the outer surface of the lamp tube 64. It should be noted that the inner diameter of the tapered coil spring 70 may be of such a size that it may have a predetermined amount of expansion to engage the tube 64 and thus ensuring a secure and reliable physical and electrical contact between the tapered coil spring 70 and the electrode 68 of the CCFL 62 according to the present invention. It should further be noted that generally the bend radius of the external wire lead or electrode 68 extending from the outside of the glass bead 66 should be approximately one half the radius of the outside diameter of the tube 64. This ensures that the electrode 68 may not be subjected to any unnecessary physical forces that may lead to weakening of the electrode 68 and possible failure of the CCFL 62 due to failure of the electrode 68.

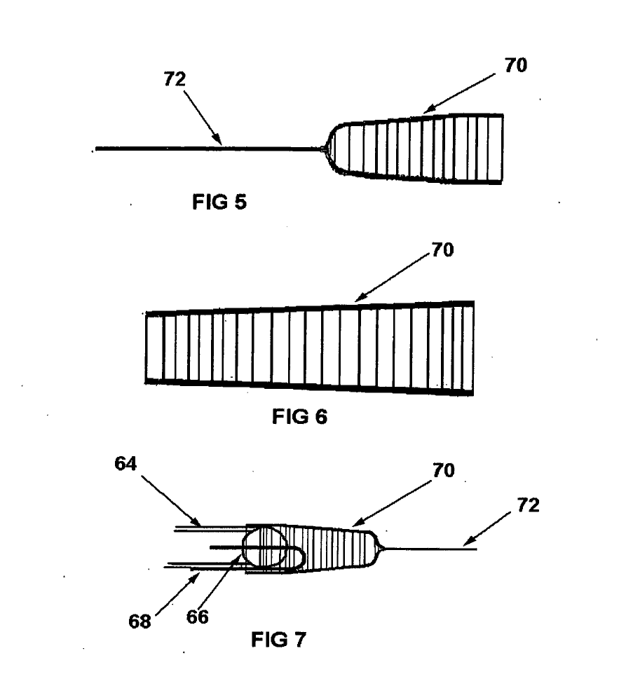

Generally, the present invention may use two types of coil spring connectors 70, however any other type of tapered coil spring connector may also be used depending on the design requirements and environment in which the CCFL 62 will be used. As shown in FIG. 5, one contemplated tapered coil spring connector 70 may have a lead 72 extending from an end thereof. The lead 72 may extend from the end that is opposite of the open end. The open end is arranged over the end of the glass tube 64 and electrode 68 extending from the glass tube 64. The lead 72 in this embodiment may be connected prior to the connector 70 being arranged over the end of the glass tube 64 such that only physical handling is required to install the wire harness to the CCFL 62. However, it is also contemplated to connect the lead 72 after the connector 70 is arranged over the end of the CCFL glass tube 64. FIG. 6 shows another alternate embodiment of the coil spring connector 70 wherein the coil spring is opened at both ends with one end having a larger diameter than the opposite end. Generally, the larger end diameter will be arranged over the end of the CCFL glass tube 64 and electrode 68. It should be noted that the winding ratio and turn spacing on the ends of either of the connector springs 70 as described are designed that they must expand to fit over the end of the CCFL glass tube 64 and electrode 68, wherein the electrode 68 is external to the CCFL 62 and parallel to the CCFL glass tube 64 as described above. The second end of the open end connector 70 may be of any size depending on the design requirements and environment in which the CCFL 62 will be used. The second end may be sized for further assembly per the application, such as a pin, rivet or some other electrically conductive or connected device being attached thereto. This will ensure that electricity will pass through the connector 70 via the contact made between the end of the connector 70 and the electrode 68 of the glass tube 64 and the opposite end of the connector 70 to the electrical circuitry necessary to operate the CCFL 62. It should be noted that in one contemplated embodiment the tapered coil connector springs 70 generally are made of a steel material, however any other metal, ceramic, composite, plastic or natural material that is capable of conducting electricity may also be used to design the tapered coil spring connector 70. It should be noted that in both embodiments a wire harness may be attached to either a single lead extending from the connector 70 or attached to a fixed position locator depending on the design of the CCFL 62 and illumination device. Spring 70 also compensates for various differences in the rate of thermo expansion of the many different kinds of material that may be incorporated in the lamp assembly. It also will dampen any vibration/shock that the tube may be subjected to.

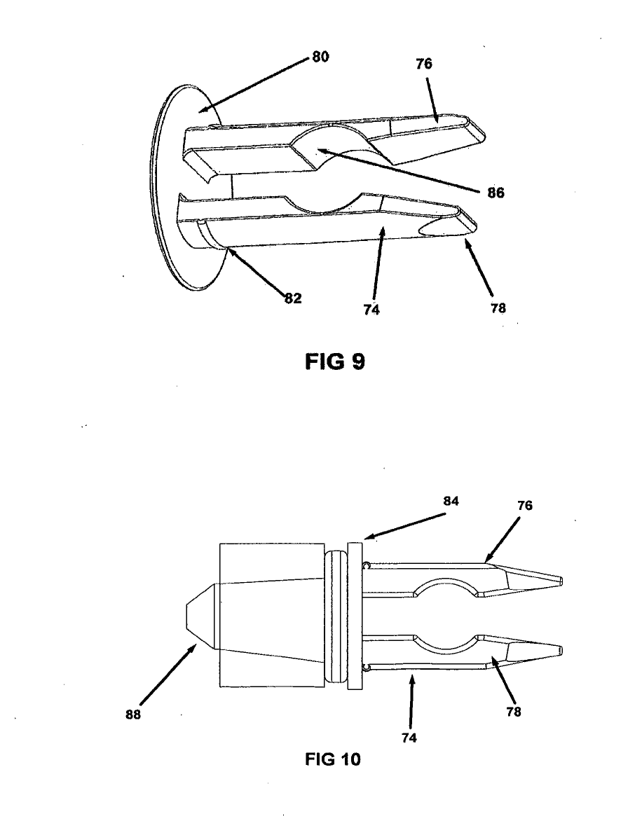

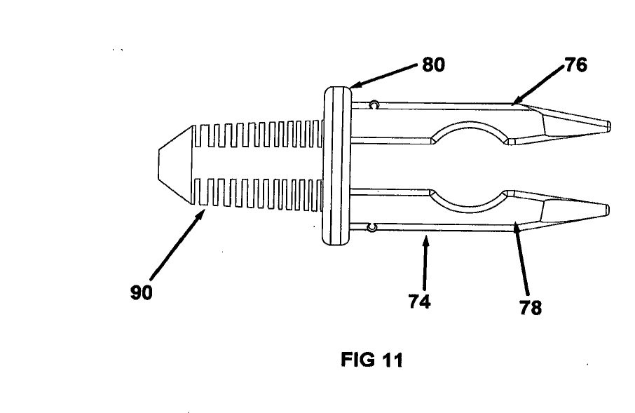

FIGS. 9 through 12 show multiple embodiments of a CCFL bulb clamping device or holder 74 for use within an illumination device of the present invention. Generally, the bulb holder 74 may have a first 76 and second finger 78 extending from a base portion 80. Arranged a predetermined distance on an outer surface of each finger 76, 78 is a predetermined height and shaped ridge or lip 82 that may extend around the entire or only a partial portion of the outer surface of each finger 76, 78. The lip 82 may be used to engage with a surface of a reflector or the like 84 within the light tube of the CCFL 62 illumination device. Generally, the tube holder 74 may be placed through a rectangular orifice or hole through the reflector or other device 84 within the CCFL light tube. It should be noted that any other shaped hole, other than rectangular, may also be used depending on the design requirements of the tubular holder 74 for the present invention. The tubular holder 74 also may include a first and second recess or cavity 86 that will mimic the outer circumference of the bulb 64 being held therein within the CCFL illumination device. Generally, the recess area 86 has a circumferential or circular shape. The recess area 86 ensures that the bulb 64 is secured within the illumination device tubing of the CCFL lamp device according to the present invention. It should be noted that multiple channels 86 may be used in each holder 74 to support multiple CCFL's 62, pipes, wires or other devices. It should be noted that the cavity or channel 86 may be of any shape and generally may mimic the outer shape of the bulb 64 being used. It should also be noted that the lamp holder 74 may have an added hook to secure a wire or other component or a catch, wire restraint may also be used with the lamp holder 74 except resized as needed to perform some other purpose, stabilization, attachment, etc. It should also be noted that holder 74 may be formed as an integral part of device 84.

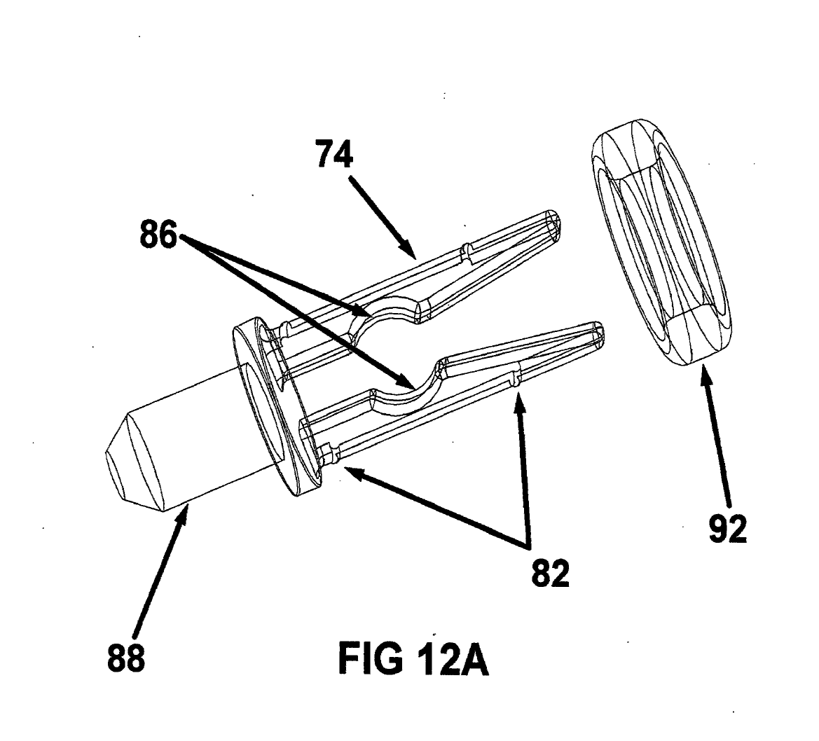

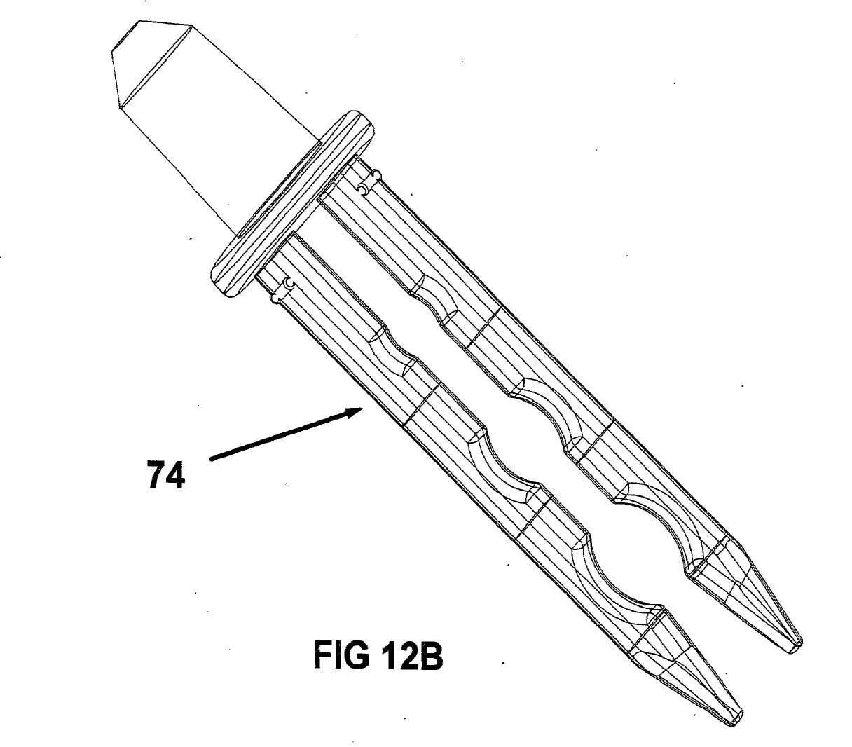

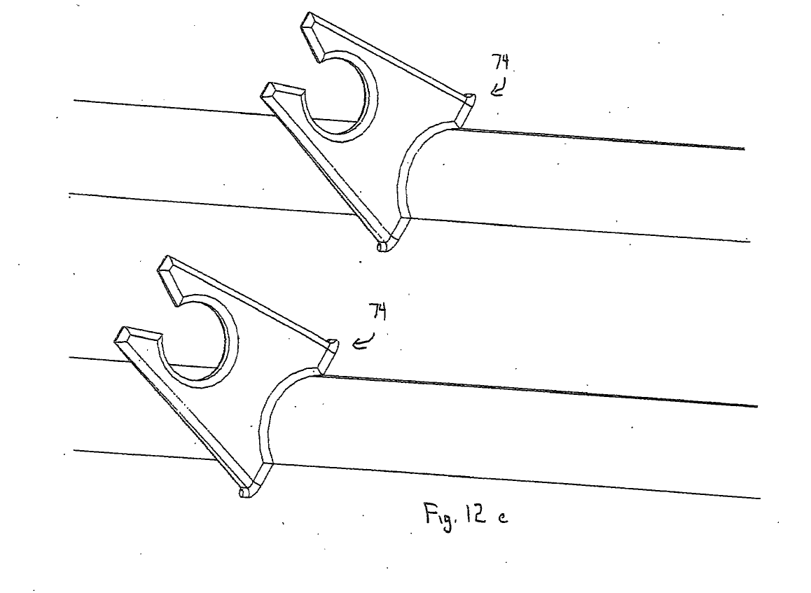

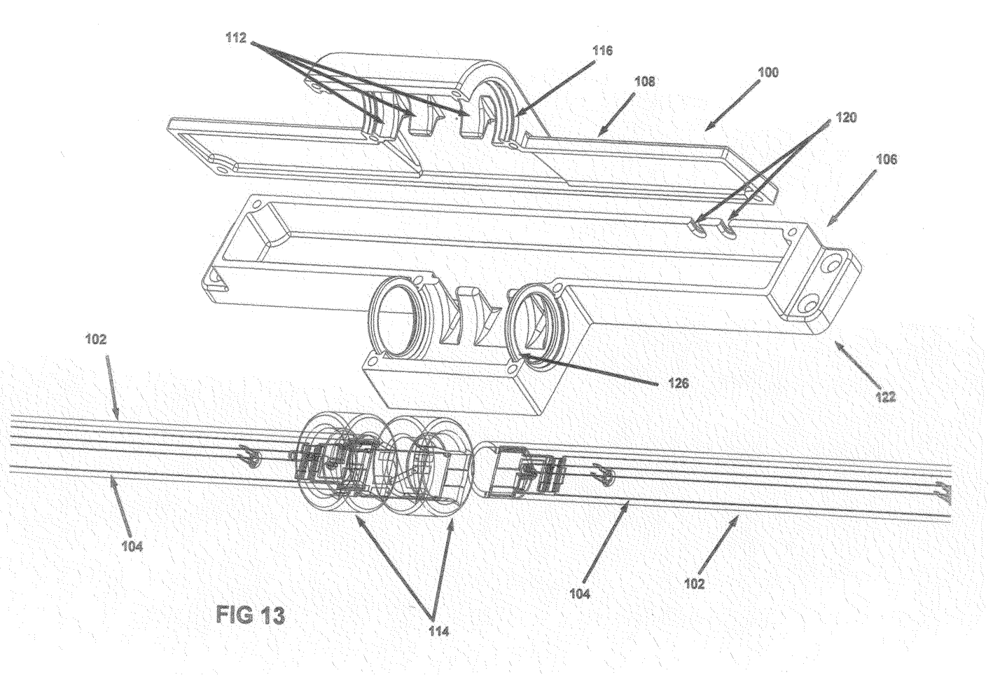

FIG. 10 shows another alternate embodiment of the tubular holder 74. It includes a predetermined shaped post or pole 88 extending from the body 80 or a side opposite of the fingers 76, 78. The post 88 may have a generally angled face on one end thereof and may be used to align two parallel parts within the light tube in addition to restraining a third if necessary. It should be noted that the post 88 may be threaded or have any other typical mechanical or chemical treatment thereon to secure various parts of various shapes thereto. Another embodiment as shown in FIG. 11 includes the elongated portion or post 88 extending from the body member with a push and retainer type surface generally including a plurality of feathered retaining fingers or edges 90 extending from the main base or pole 88. This will allow for the bulb holder 74 to be placed within the reflector or other device 84 within the light tube and be secured therein without the need for the retaining lip or ridge as described above in FIGS. 9 and 10. FIG. 12 shows yet another embodiment of the bulb holder 74, which may be used in conjunction with the extension or pole 88 extending from the body 80 in conjunction with a first and second retaining ridge 82 or lip 82 arranged on the outer surface of each of the fingers 76, 78 extending from the outer surface thereof. It also includes a snap on retainer ring 92 that may engage with two of the retaining ridges or lips 82 to secure the bulb 64 within the predetermined shaped holding orifice within the fingers of the bulb holder 74. It should be noted that any of the bulb holders 74 may be used in the application as currently shown through a reflector, through pipe, an electrical wire, wood or metal studding depending on the design requirements and environment in which the present invention will be used. It should also be noted that it is generally contemplated to have all of the parts for the bulb holder 74 to be made of a plastic material, however any other metal, ceramic, composite, natural material or the like may also be used for the bulb holder 74 according to the present invention. It should be noted that multiple bulb holders 74 may be used in the present invention depending on the design requirements of the CCFL lamp and illumination device. The bulb holder 74 may have any known tubular shape or any other known shape that will fit and be held in the device, such as a pipe, wire, other part, etc.

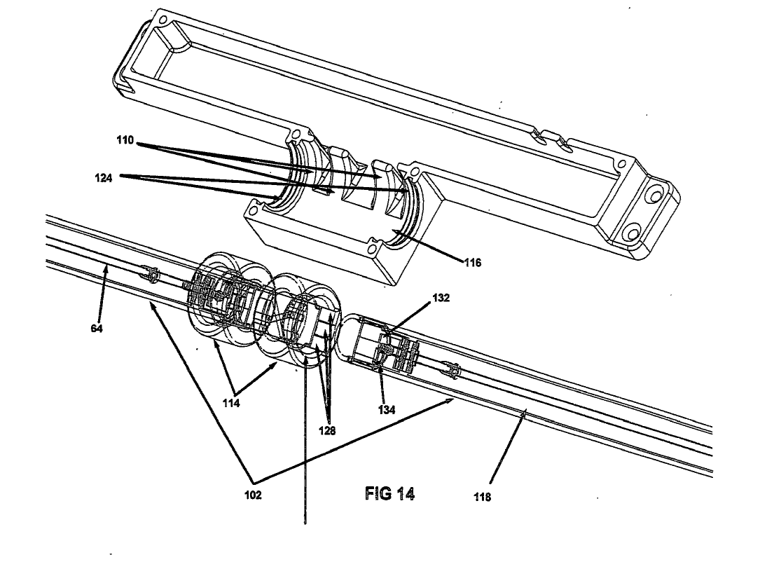

FIGS. 13 through 14 show an embodiment of a single and double lamp tubular fixture or device 100 according to the present invention. Generally, this is a low profile light fixture 100 that has one or two CCFL lamps 102 each independently rotatable within the fixture 100, such that the light tube 104 can be directed to a predetermined angle with relation to the user of the light tubular fixture 100. Generally, the lamp fixture 100 has a body 106 that has a generally T-shape when viewed from above, however the fixture may be of any shape to fit any application. A cover 108, having a generally T-shape, also is arranged over and connected to the body 106 via any known fastener, such as screws, snap fit arrangements or any other mechanical or chemical fastening methodology. The body 106 has a plurality of bearing surfaces 110 that will mate with and interact with a plurality of bearing surfaces 112 arranged on a predetermined portion of the cover 108. Generally, these bearing surfaces 110, 112 have curved shapes that will receive generally cylindrical or circular rotating members 114 that are arranged therein. These bearing surfaces 110, 112 generally are molded into the extension or small portion of the T-shaped body 106 and cover 108. These extension portions also may each include a generally circular orifice 116 arranged on each end thereof for allowing a lamp tube 104 to pass therethrough. The lamp fixture 100, as shown in FIG. 13, has the body 106 and cover 108 made of generally a plastic material that is molded with predetermined specifications. It should be noted that any other type of material, such as any other known plastic, ceramic, composite, natural material, metal, or the like may be used for the lamp fixture device 100. It should be noted that the body 106 includes an inner bore or cavity 118 therein which will be used to hold the necessary electronics to operate the lamp 100. The body 106 also may include a plurality of orifices 120 to allow for wiring or the like to pass therethrough and a plurality of orifices 122 to allow for mounting of the lamp device 100 on a wall or similar surface for use by a consumer. The cover 100 and the body 106 include a generally circumferential groove 124 along the circumferential orifice for passing the light tube 104 therethrough. Generally, the groove 124 may provide for a seal 126 to be arranged therein that will allow for the seal 126 to be arranged between an outer surface of the light tube 104 and the seal within groove 124 thus completely waterproofing the assembly 100. It should be noted that the length and inside diameter of the body extension may be any known dimension that provide alignment and cantilevered support for the CCFL 102 and provide adequate pressure such that proper electrical contact occurs between spring loaded contact 128 arranged on a circuit board 130 that are arranged within the rotating members 114 of the device 100 and the electrical contacts 134 arranged on a circuit board 132 that is connected to the bulb 64 of the CCFL 102 as described above. Generally, the circuit board 130 is rotatably fixed with respect to the rotating member 114 and provides a plurality of spring loaded contactors 128 that extend a predetermined distance from the outer surface of the circuit board 130, thus ensuring proper electrical contact with a circuit board 132 connected to the CCFL 102 as described above. The circuit board 130 arranged within the rotating members 114 also have the appropriate electrical wiring and such connected to the internal circuitry of the lamp device 108 according to the present invention. It should be noted that in one contemplated embodiment the spring loaded contacts 128 are common with low input power voltage and that two of the spring contacts 128 are connected in series between the input power lead and the input of electronics in powering the circuitry. When the hot contact of the circuit board 132 of the CCFL 102 engages the two contacts 128 arranged within the rotating members 114 the circuit is completed and power is passed through to the CCFL bulb 64. It should be noted that the contacts are also connected to the high voltage side of the driving circuitry. This electrical circuitry will sense when the contacts are connected to the boards and allow power to drive the CCFL circuitry. This configuration will ensure no high voltage is present at the contacts 128 when a CCFL 102 is not arranged therein, thus providing a high level of safety and convenience when changing out complete lamp tube assemblies such as those shown in FIG. 14.

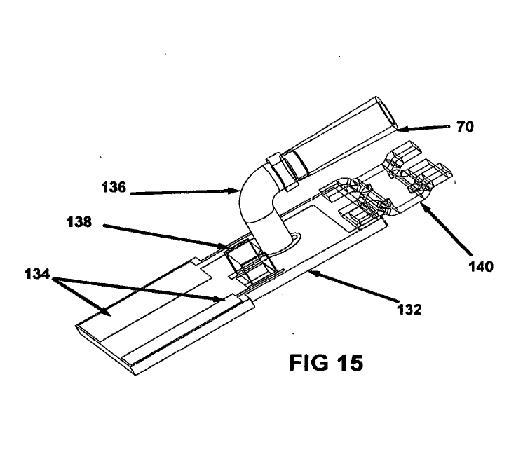

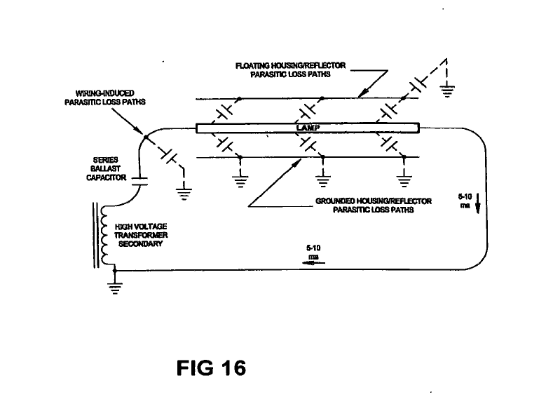

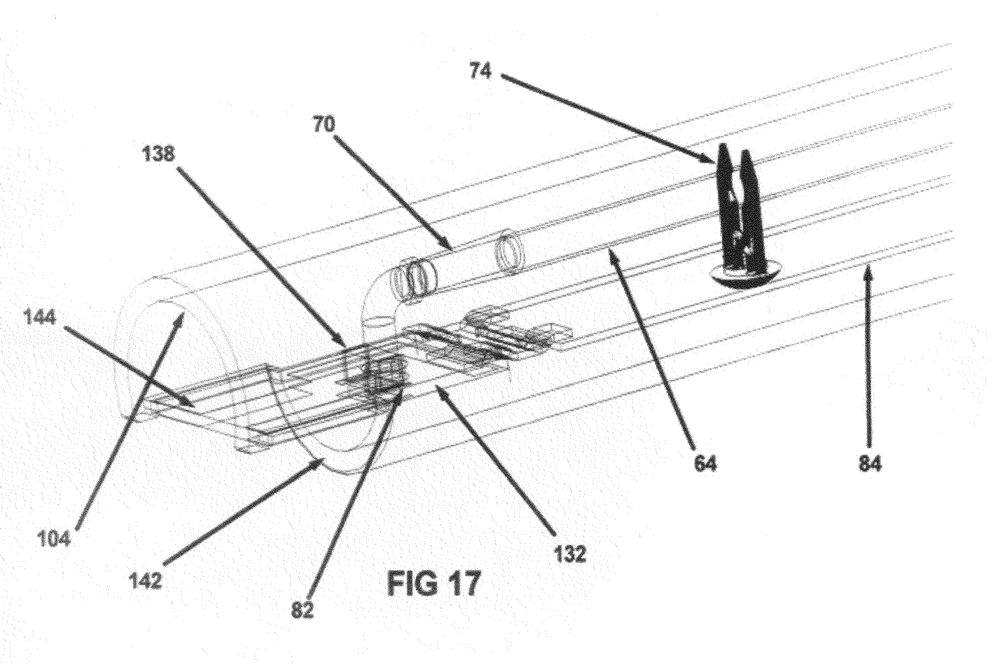

It should be noted that the electrical circuitry for the CCFL 102 is generally shown in FIGS. 15, 16 and 17. The tapered spring connector 70 is generally shown without the light bulb 64 connected thereto. Generally, the spring connector 70 is connected to a receiver member 136 which is in contact with the circuit board 132 of the CCFL 102. A capacitor 138 may be arranged on the circuit board 132, depending on the electrical requirements of the lamp 100. It should also be noted that two capacitors 138 may also be arranged, one on each side of the circuit board 132, depending on the electrical requirements of the CCFL 102. Furthermore, the electrical requirements may not always be met with a single capacitor value, such that the two capacitors are needed for each CCFL 102 connected to the circuit board 132 utilizing a surface mount technology coupling capacitor 138, i.e., a series ballast capacitor is needed, because the electrical characteristics and relationship between the CCFL 102 and its driving circuitry. It should be noted that the desire to provide replacement lamp tube assemblies, even though the long interval between change outs may occur, will lead to possible manufacturing and electrical characteristics of CCFL's changing over time. Thus, it will be advantageous to be able to couple new lamp assemblies with legacy driving circuits that endeavor to maintain the design efficiency of the overall total fixture life. The circuit board 132 also includes electrical contacts 134 which will drive the circuitry of the CCFL 102. A bracket 140 generally engages one of the contacts 134 on one end of the electrical circuit and the reflector/conductor 84 on an opposite end thereof. The bracket 140 ensures electrical conductivity occurs between circuit board 132 and a coil spring connector 70 connected at the opposite end of the bulb 64 on the opposite end of reflector/conductor 84. Thus, this will allow power to pass from contact 134 and capacitor through bracket 140 and reflector/conductor 84 to the spring connector 70 arranged and connected electrically at the opposite end of the reflector 84. The receiving member 136 that is arranged between the coil spring connector 70 and circuit board 132 provides positioning and also keeps thermal and physical forces from reaching the light bulb 64 and also acts as an electrical conductor therebetween. A metal bracket 140 engaging contact 134 and the metal electrical conductor/reflector 84, power passes therethrough. It should be noted that if the reflector 84 is made of a non-conductive material another means of connecting the two spring connectors 70 to the circuit board 132 may be used, such as a wire or other electrical conducting methodology.

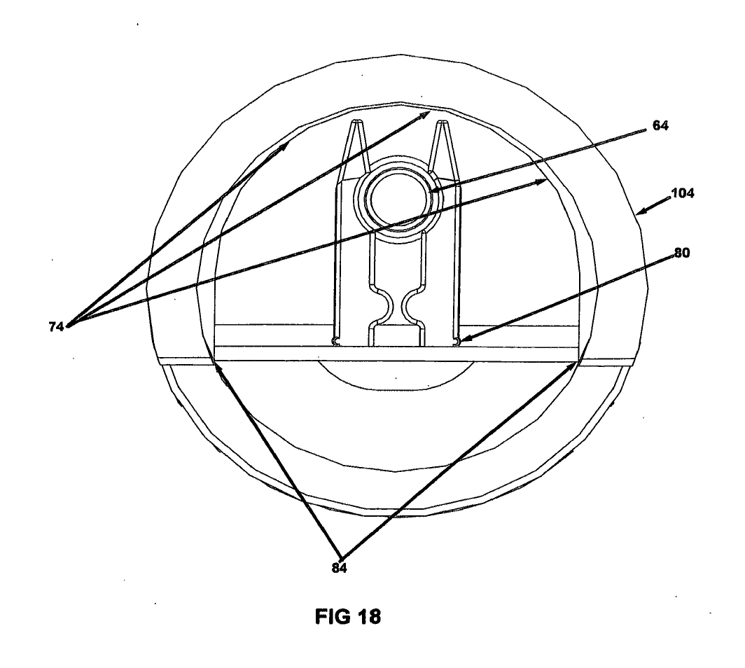

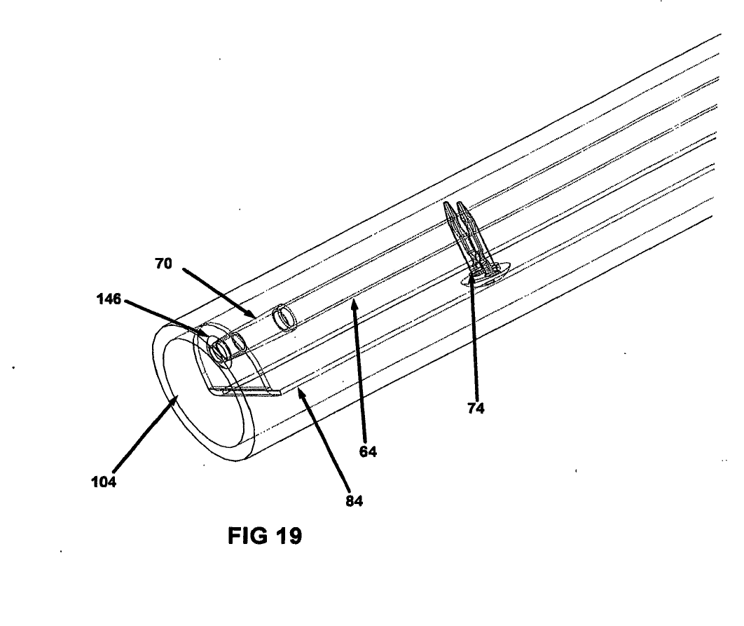

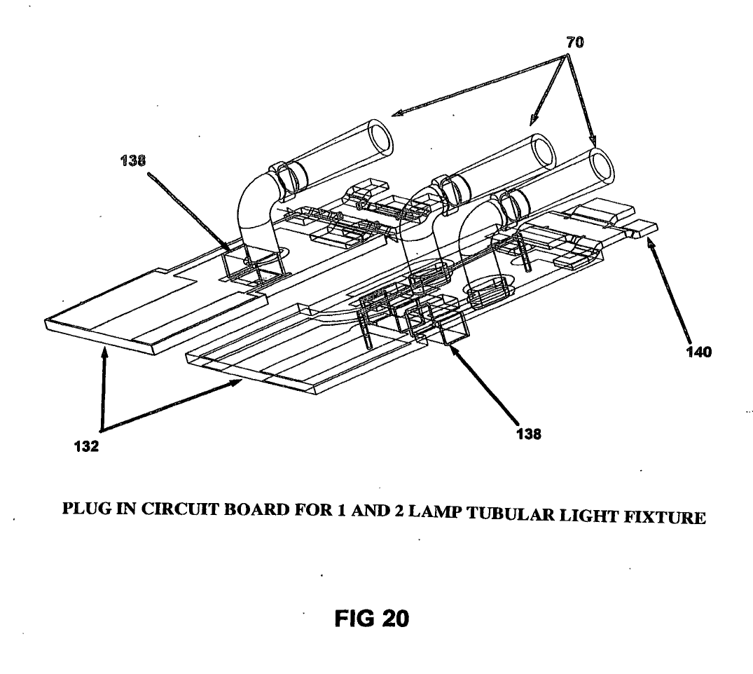

The rotating member 114 may have the circuit board 130 arranged therein such that it rotates therewith and the rotating members 114 may be free to rotate with respect to the body 106 of the lamp fixture 100. This will ensure that the light from the CCFL bulb 64 will be directed to a predetermined position that the user of the light needs. This rotation will allow for up to 360° rotation of the light with relation to the body 106 of the lamp fixture 100. The CCFL bulb 64 and associated reflector 84, bulb holder and circuit board as described above, will all be arranged within a light tube 104. The light tube 104 generally is made of a plastic material, however any other natural material, ceramic material, composite material or the like may be used such as glass, ceramics, clay or the like. Generally, one end of the light tube 104 will have a notch 142 arranged therein with an indentation 144 which allows for retention and securing of the circuit board 132 of the CCFL 102 to be smoothly inserted therein. This indentation 144 on the inside surface of the light tube 104 will allow for precise location of the CCFL bulb reflector 84 and circuit board 132 with relation to the light tube 104. It should be noted that any dimensioned diameter or length light tube 104 may be used depending on the design requirements and environment in which the lamp 100 will be positioned. It should be noted that in one contemplated embodiment as shown in FIGS. 18 and 19, the outer edges of the fingers of the lamp holder 74 will engage with the inside surface of the lamp tube 104 while a surface of conductor and reflector 84 will engage with an interior surface of the lamp tube 104, thus immobilizing the light bulb 64 from upward movement within the interior of the light tube 104. Each end of the light tube 104 may also be sealed to ensure leaking of mercury or other chemicals used for the CCFL bulb 64 into the atmosphere, thus causing a potential hazmat situation. It should be noted that the ends of the spring connectors 70 may be connected to the end of the folded up portion of the reflector/conductor 84 via any known fastener 146 such as a rivet, screw, or any other known methodology, chemical or mechanical for connecting the end of a tapered coil spring connector 70 to a metal surface. It should further be noted that it is also contemplated as shown in FIG. 20, that any type of configuration of one bulb 64 or multiple bulbs 64 being connected.

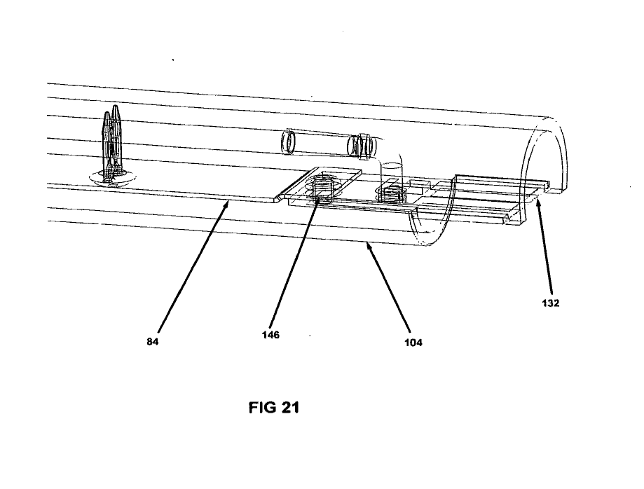

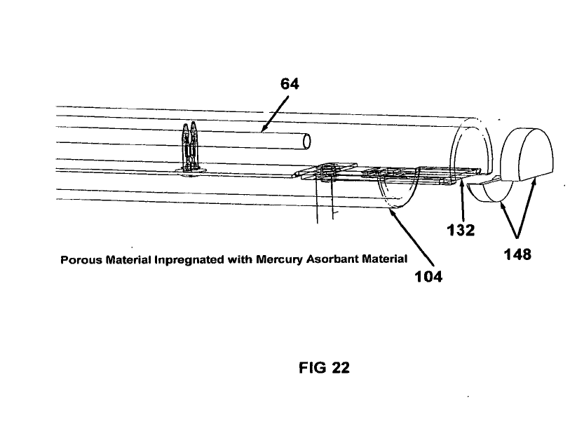

As shown in FIG. 21 it is also contemplated to use a rivet or other metal connector 146 to connect reflector/conductor 84 having a slight bend in one end thereof to circuit board 132 in essence replacing connector 140 as described above. However, it is also contemplated to use connector 140 as described above in any or all of the inventions. Furthermore, there are regulations existing or pending regarding the toxic distribution of mercury as contained in CCFL's and other fluorescent bulbs. Therefore, it should be noted that the lamp tube 104 may be plugged at both ends hermetically sealing it, thus not allowing any mercury from exiting the internal area of the lamp tube 104. In one contemplated embodiment the material 148 may be composed partially of carbon or nano particles of selenium that will bond or retain mercury and may be arranged in the outer openings of the lamp tube 104. One or both ends of the lamp tube 104 may be plugged, such as the material 48, having generally partial circular shapes, as shown in FIG. 22. It is further contemplated that any porous material capable of absorbing mercury or water vapor, if present in the interior atmosphere of the lamp tube 104, may be used if an atmospheric pressure differential exists and that the interior atmosphere will move toward the exterior atmosphere, thus allowing for absorption by the material 148 plugging the ends of the lamp tube 104. Furthermore, it may also be desirable to place the porous material 148 for plugging the ends in cavities between the reflector 84 and the inside surface of the lamp tube 104.

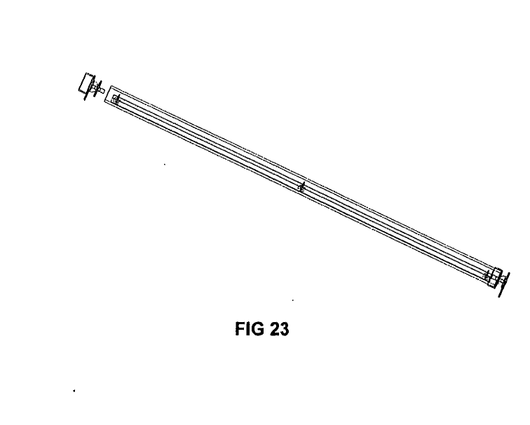

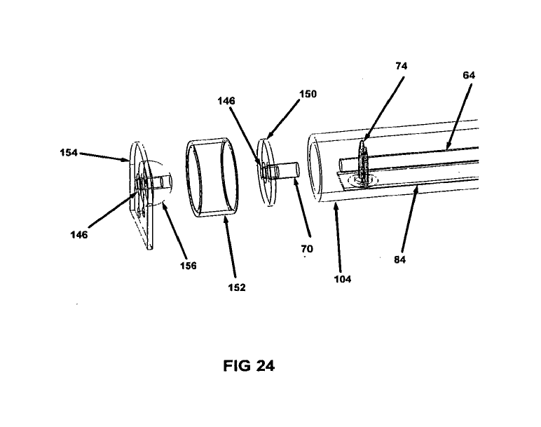

FIGS. 23 and 24 show yet two more embodiments of the present invention. This embodiment includes the generally clear lamp tube 104, a CCFL light bulb 64 arranged therein and a bulb holder 74 as described above arranged through and connected to the reflector 84 that is arranged along the entire length of the bulb 64. The connector spring 70 is arranged over the end of the light bulb 64 and a mounting pin 146 connects the connector spring 70 to a first washer 1 in the embodiment shown. Next a retainer sleeve 152 having an inside diameter generally less than the outside diameter of the light tube 104 will retain the first washer 150 against forces of the connector spring 70. Then a second washer 154 generally having a keyhole shape or square shape with a semi circle top. It should be noted that any other shape may be used for the washer 154. The washer 154 may also include a mounting pin 146 attached on one end thereto with a wire extension therefrom for attaching a second wire lead attachment thereto. It should be noted that washer 154 generally will be arranged to fit within a housing with a slot to restrict lateral movement thereof. Mounting pin 146 extends from the opposite end of the washer 154 and provides for an electrical connection between the connector 70 connected to the bulb 64 and the washer 154 electrical connector 146. This will allow for a complete 360° rotation because the conductor member 156 may be in constant contact with the mounting pin 146 that is connected to the connector 70 on one end thereof even though 360° of rotation may occur, hence the connection will always be electrically closed. On the opposite end a second mounting pin 146 may be connected to the opposite end of rotating conductor 156, thus allowing for electricity to pass through to the CCFL light bulb 64. It should further be noted 104 that the light tube is hermetically sealed such that mercury containment occurs therein. It should further be noted that it is contemplated to have one or more capacitors 138 extend from an outer surface of the first washer 150. In one contemplated embodiment the mercury absorbent material 148 may also contain a water absorbent material or carbon and an associated container or collator 149 at or near an end of the lamp assembly. The container 149 may have orifices for pressure equalization. The material 148 controls water vapor inside the container. Also, a water absorbent material may be a separate material if mercury containment is not an issue, or the two attributes may be combined into one component or the two parts may be assembled within the assembly separately. It is also contemplated to have a non conductive heat resistant material in the shape of a cylinder 158 to absorb lateral forces that would otherwise be imparted upon the coupling capacitors 138 that may be arranged and extending from the first washer 150. A third washer 160 may also be backed upon cylinder 158 prior to being slid over retainer sleeve 152.

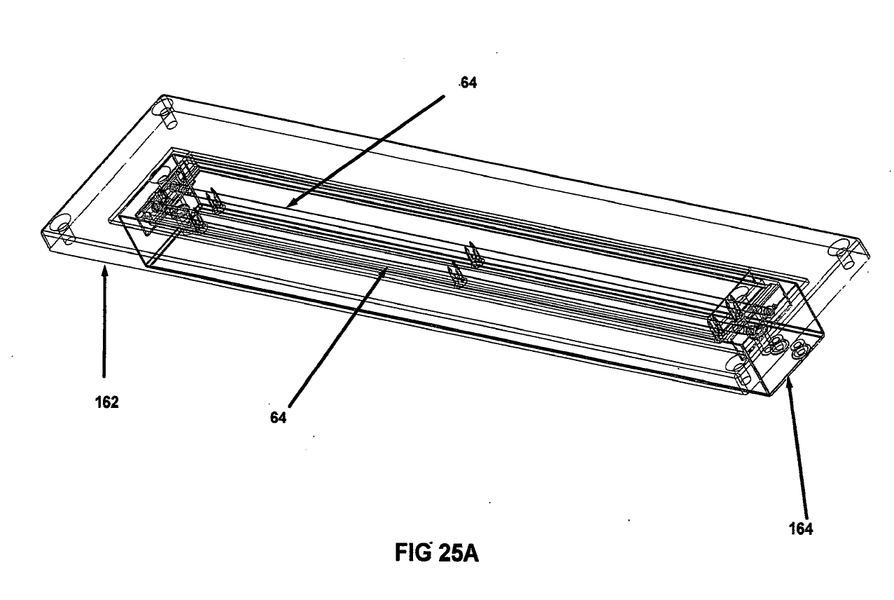

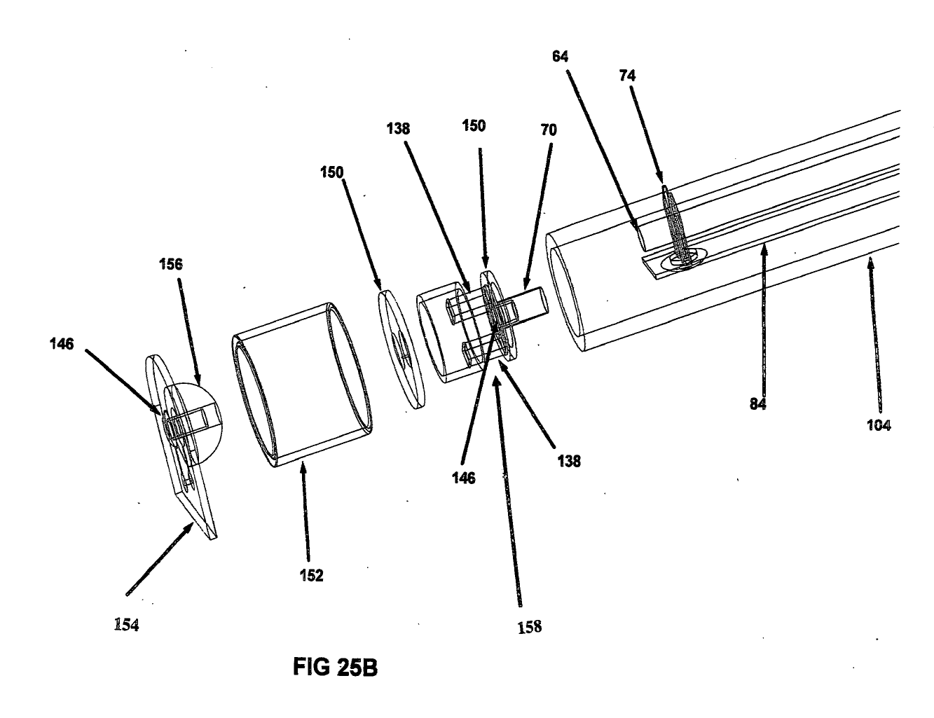

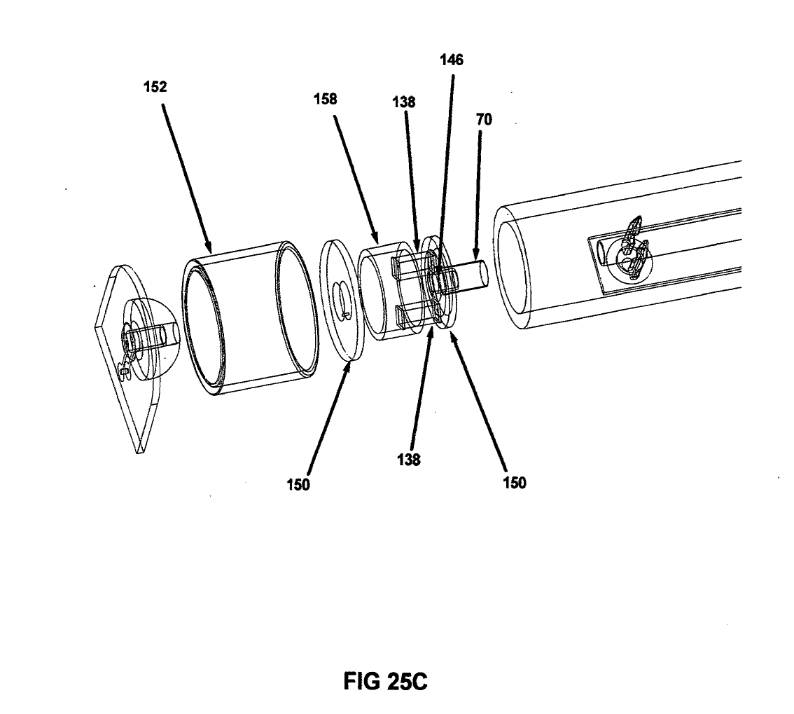

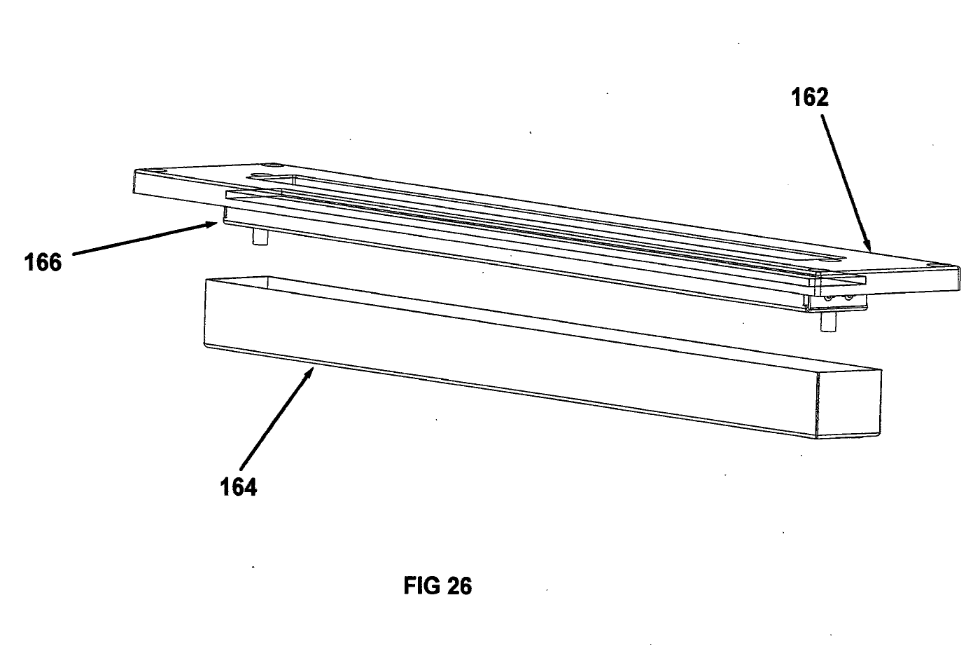

FIG. 25 shows another embodiment of a rectangular light fixture 162 that may contain any number of CCFL's 102 of any length or diameter. The top portion of the light fixture may be of any dimension and appropriate to the application needs while the bottom section 164 of the light 162 may contain the electrical components that may vary in width and depth as necessary to accommodate the components and size of the CCFL light bulbs 64 and electronics therein. It should be noted that the lower section 164 may also have fins or other exterior cooling means to facilitate operation in adverse environments while the unit may also be hermetically sealed with a seal 166 to ensure no mercury or water is leaked from the CCFL 102 in case of failure. It should also be noted that the upper and lower portions are intended to be one replaceable housing, each with a self contained sealed unit, but not limited to having any of the other attributes contained as described for the CCFL and associate lamp inventions.

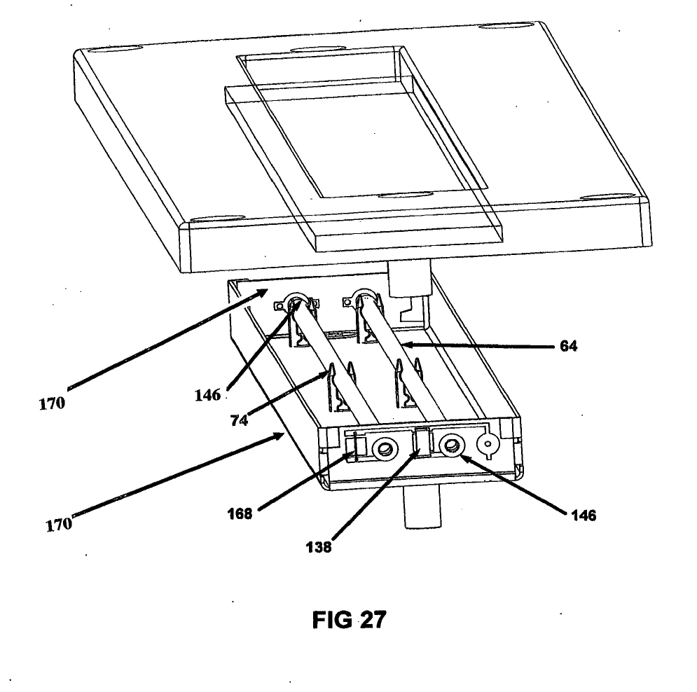

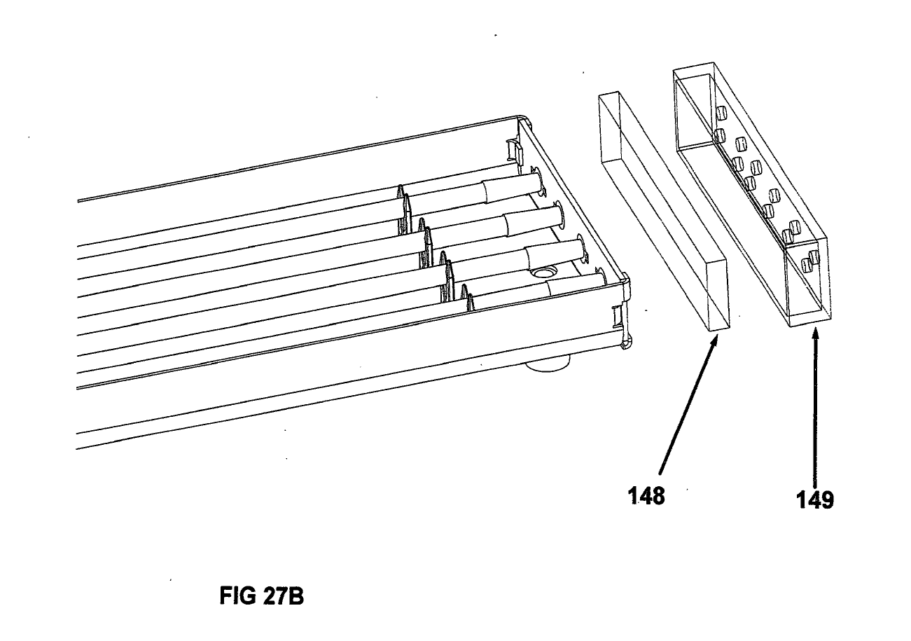

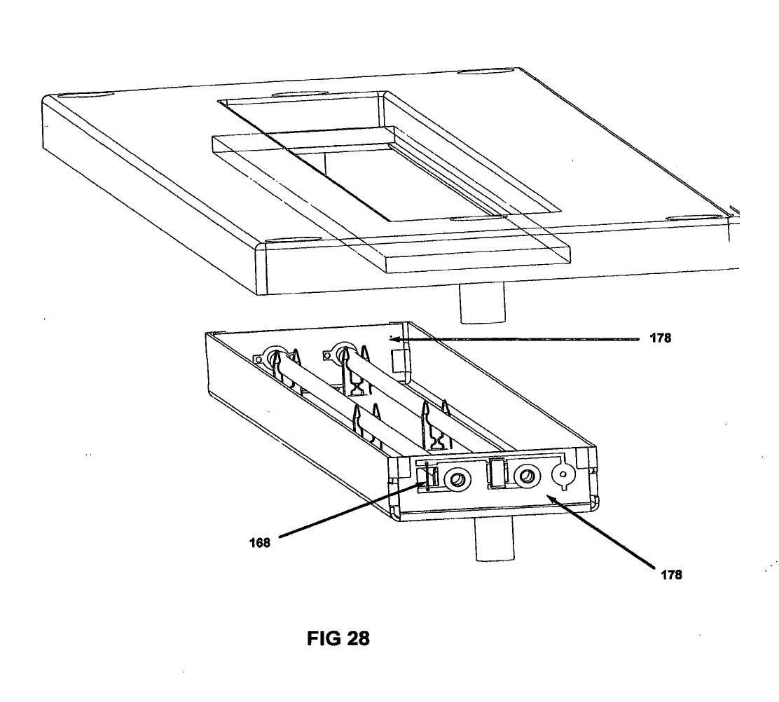

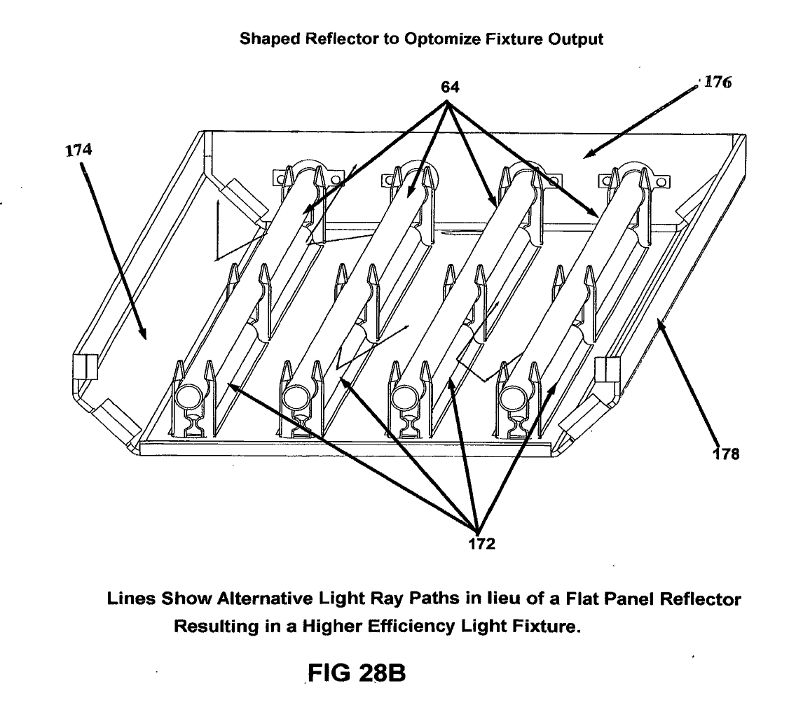

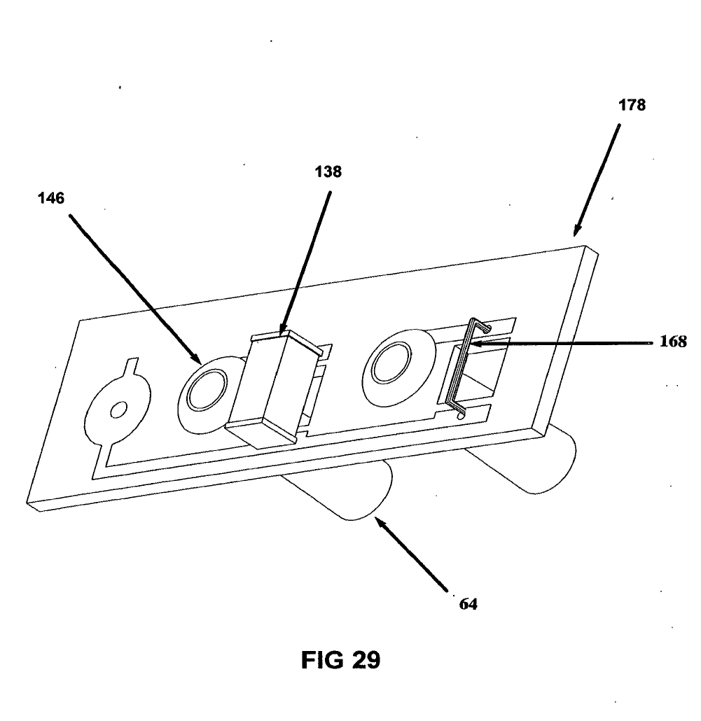

As shown in FIGS. 27, 28 and 29 it is also contemplated that a jumper 166 may be arranged on the side of one of the sections of a generally rectangular light fixture 170 to ensure the electricity passes to both ends of a multi CCFL bulb 64 lighting arrangement when no capacitor 138 is needed or used in certain embodiments. Furthermore, it is also contemplated to have predetermined shaped reflectors 172 and flat panel reflectors 174 and curved reflectors 172 arranged within the cavity 176 of a rectangular light fixture 178 to further increase the efficiency of the light fixture 178 that uses tubular light sources. The angled sides 174 generally will reduce the amount of trapped light versus sides that are 90° or at right angles to the bottom portion thereof. The continuous curving depiction of a profile such as that on the bottom surface further enhances the ability of the light rays to escape the structure, thus allowing for more light to escape and increasing the efficiency of the rectangular lamp 178. It should be noted that the that size, radius, shape and angle of the angled parts are governed by many factors, including but not limited to the diameter of the light source, the distance of the light source to the structure bottom, the distance of the light source to the top of the structure and the width of the structure. It should further be noted that many multiple versions of the rectangular light fixture 178 may be used such that there are provisions for one or two, one each side, or a coupling capacitor 138 if not needed a jumper 168 to be arranged therein to allow for many different variations and abilities to use multiple light bulbs 64 within a rectangular lamp setting.

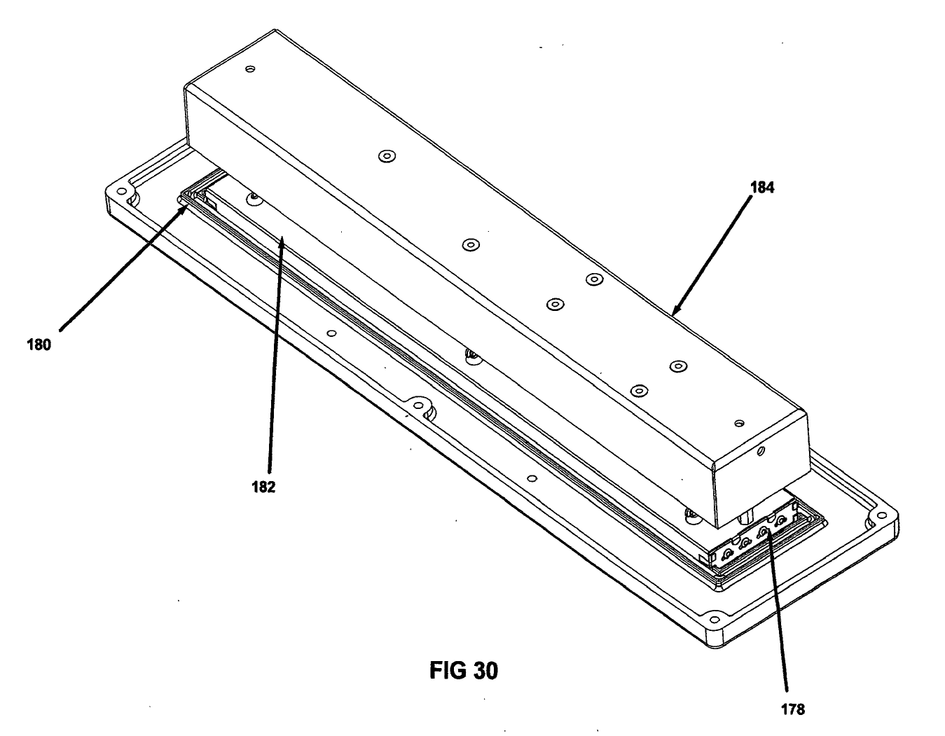

FIG. 30 shows a gasket provision groove 180 along the entire inner periphery thereof that will allow a seal 182 to be arranged therein and thus create a container including the CCFL bulb 64 for containment of mercury. Furthermore, with the gasket 182 arranged in the groove 180 may provide a structure impervious to contamination from either inside sources or leaking from the outside sources. It should further be noted that the outer shell 184 with the electronics has an expected life of approximately 400,000 hours requiring five lamp change outs due the life of the lamp structure that are described herein.

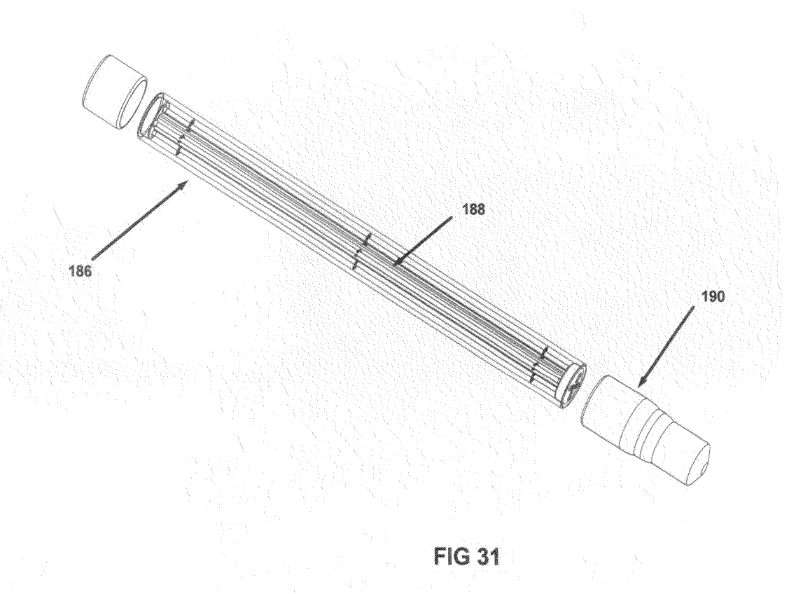

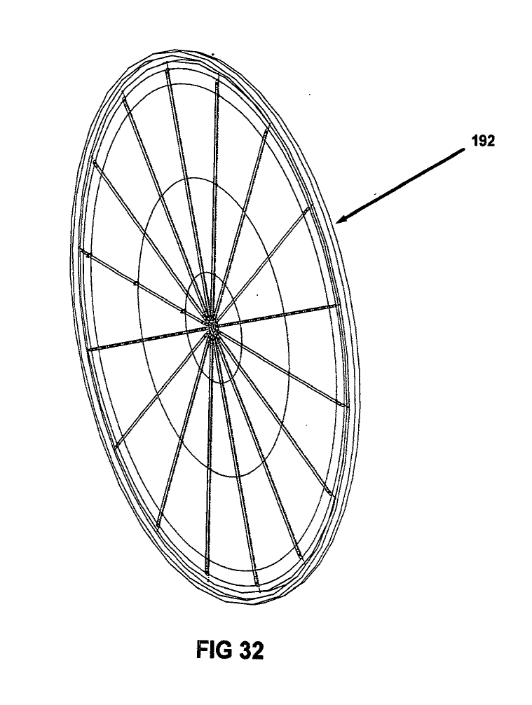

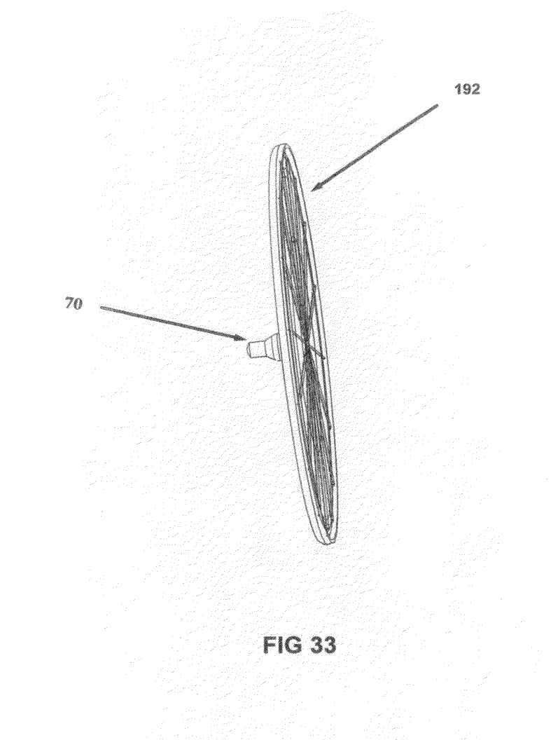

It should further be noted that FIG. 31 depicts an elongated device 186 configuration that may consist of one or up to four plus lamps 104 positioned around a circular shaped reflector 188 fitted with a standard bulb base 190. Also, as shown in FIGS. 32 and 33 it is also contemplated to use the above described CCFL light fixtures according to the present invention with a low profile fixture with the CCFL's mounted radially on a flat or conical shaped reflector 192 with associated spring connectors 70 and other hardware as described above.

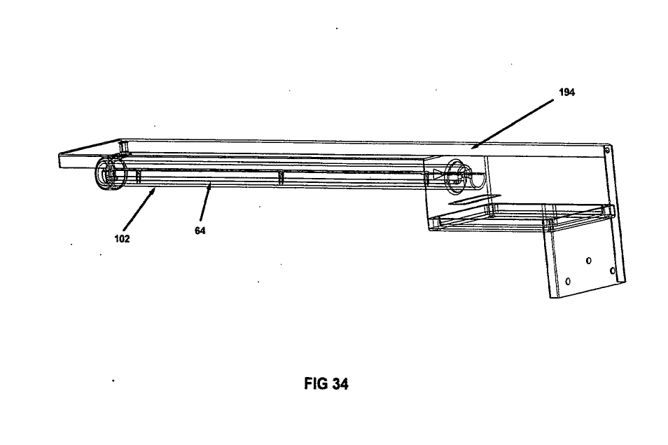

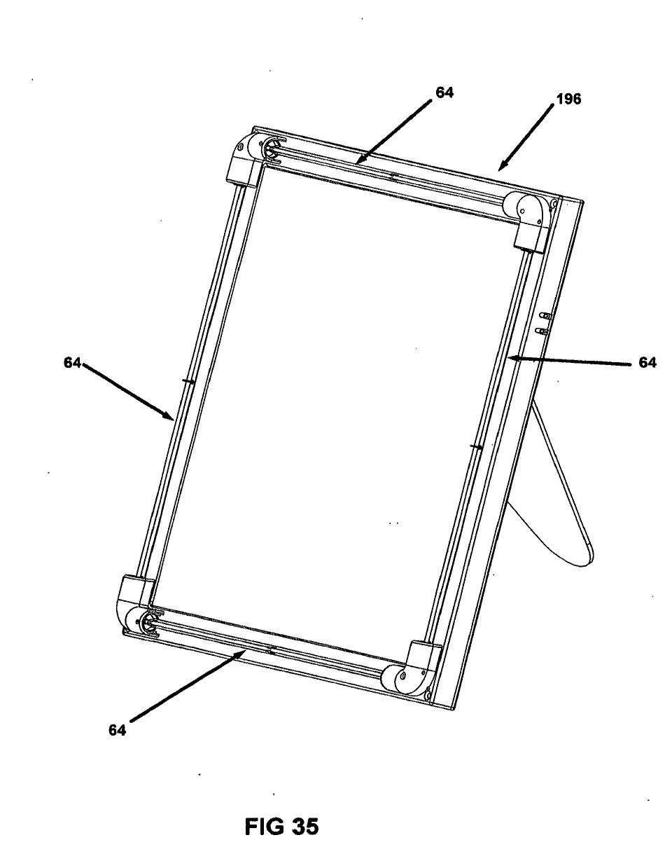

FIG. 34 also shows according to the ideas described above a cantilevered light fixture 194 or as in FIG. 35 196 a frame of either a rectangle or other shape that will provide light on an object mounted in the frame, fit around another object, the center section may be open without support, as fitting around a fan housing or ventilation vent or other structure.

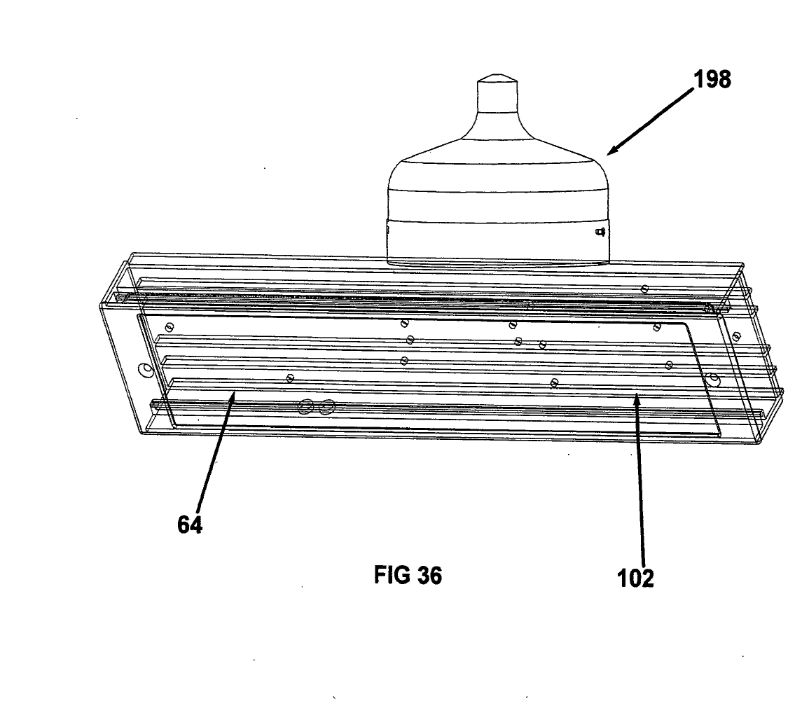

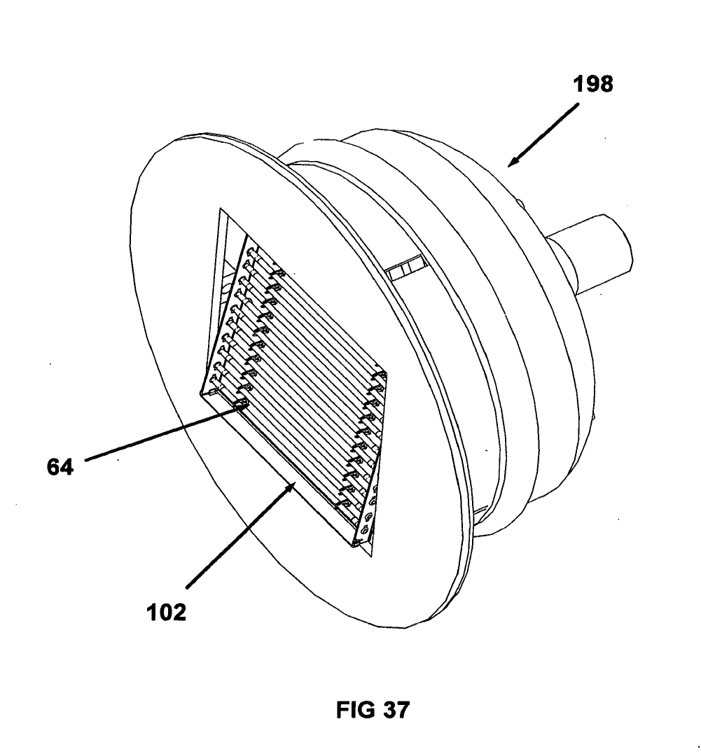

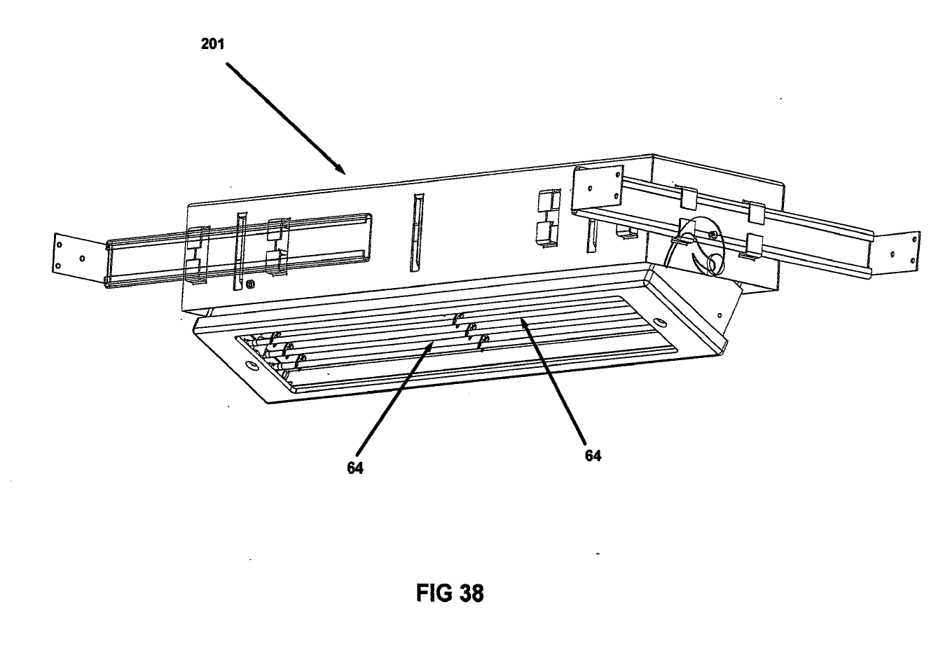

It is also contemplated as shown in FIGS. 36 and 37 the CCFL's 102 as described above fit into standard residential/commercial ceiling can fixtures 198 with adjustable angle lamp unit or within a standard residential/commercial ceiling can fixture 198 with adjustable angle lamp unit as shown. FIG. 38 also shows another design that is contemplated that it can be used in new construction such as a ceiling light fixture 201 or other recessed application that has commonality of the primary parts with the other designs described above including the outer shell and brackets. Therefore, the CCFL's 102 and connecting methodologies described above may be used in any of the applications shown in the Figures and described herein. Therefore, there is no limitation as to the use of the connector spring 70 methodology with the light bulbs 64 of a CCFL 102 and/or the connecting methodologies of the CCFL bulb 64 within a light tube 104 and the associated electronics that allow for rotation thereof in order to guide the light to predetermined positions and directions.

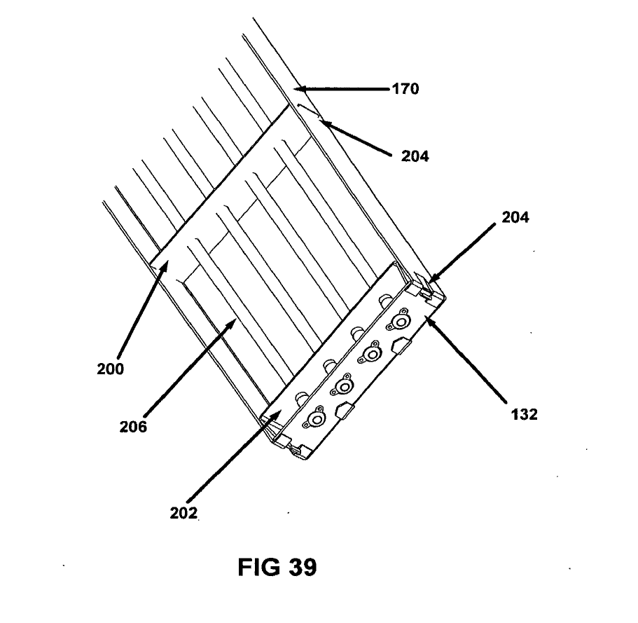

FIG. 39 shows stabilizer members 200 and 202 which stabilize the CCFL's 206, they may engage in slots on the side, bottom or any other place that is appropriate for the given application of the light fixture 170 and slots 204 in the circuit board 132. The distance between member 202 and circuit board 132 may be such that an electrical interference is resultant. It is contemplated that the material may be electrically nonconductive and it may be optically transparent.

Although only one each of the members 200 and 202 is shown it is assumed that two of 202 may be used, one at each end of 170, the number of members 200 used may be influenced by the anticipated application requirements.

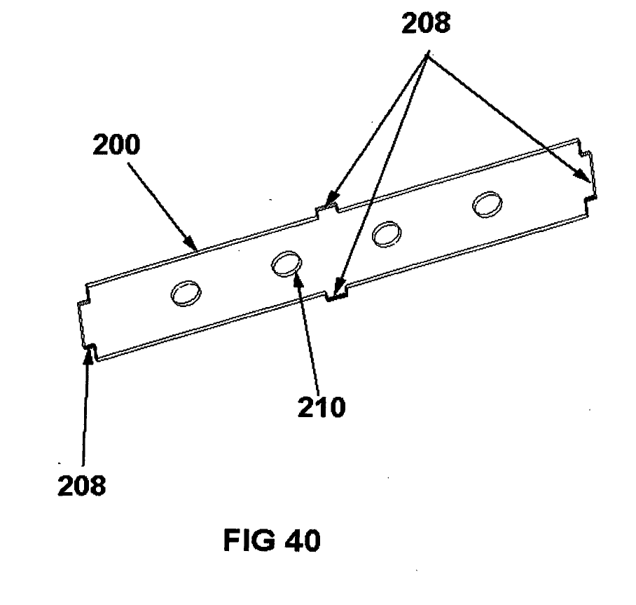

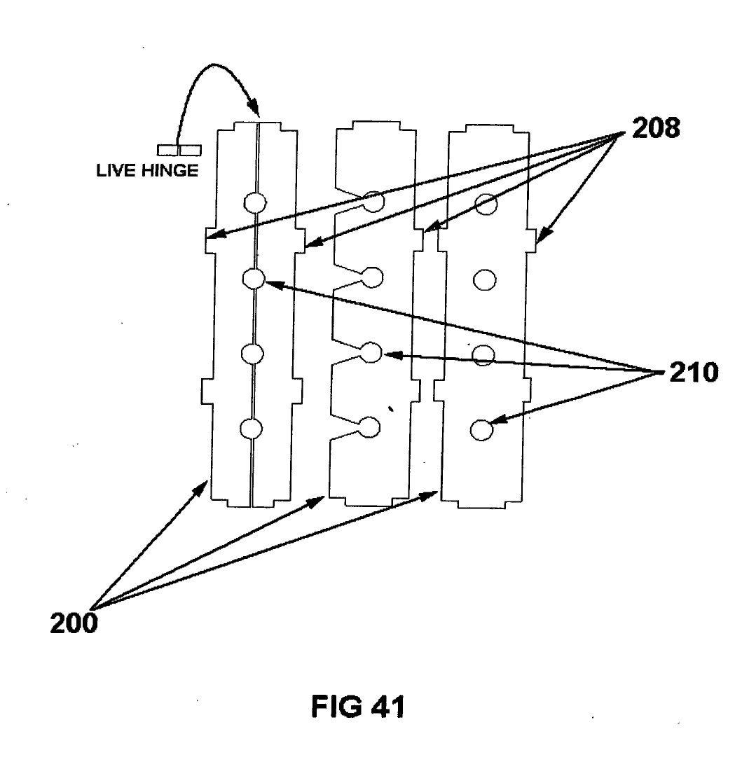

FIGS. 40 and 41 show member 200 having a shape to fit within the interior of light fixture 170, holes 210 are sized to permit CCFL 206 to fit therethrough. Tabs 208 may be straight or bent and may be used to locate member 200 within fixture 170. It is contemplated that the material may be electrically nonconductive and it may be optically transparent.

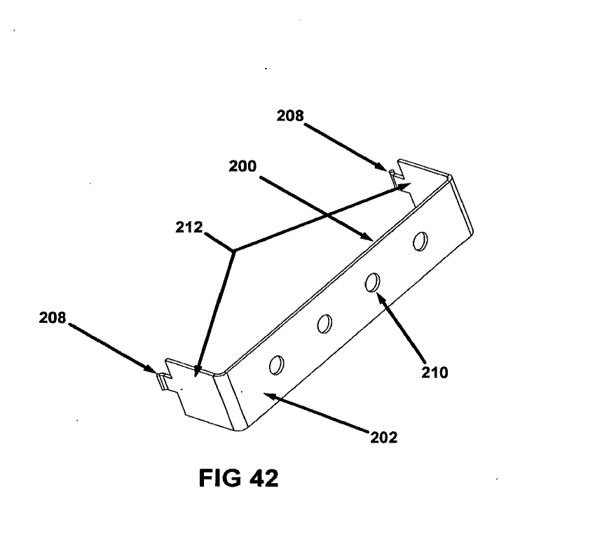

FIG. 42 shows member 202 designed to fit at an end of fixture 170 and engage tabs 208 in slots of the circuit board 132. Member 202 may also have additional tabs as member 200 does in one contemplated embodiment and engage in fixture 170. The length of flange 212 is such that member 202 is electrically isolated from other parts attached to the circuit board 132. It is contemplated that the material may be electrically nonconductive and may be optically transparent.

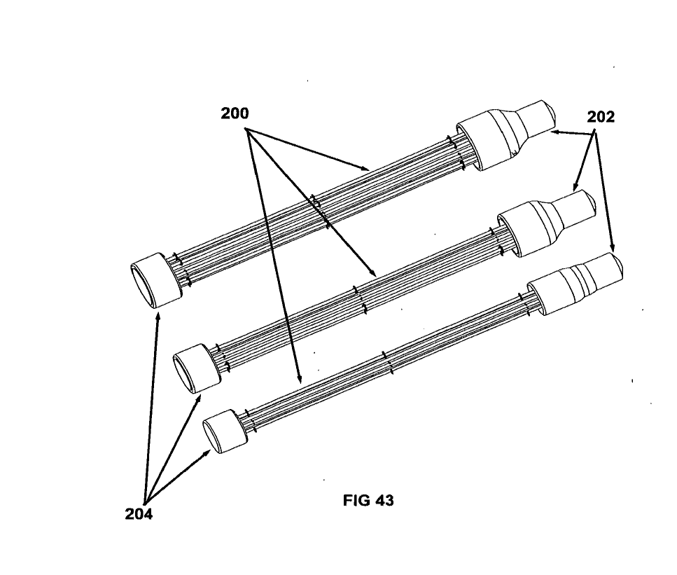

FIG. 43 shows various configurations of CCFL 200 for replacement of other type fixtures that screw in lamps. Base 202 contains electronics and a disc like member 220, and cylindrical like member 230 and engages tube 106. CCFL 200 may incorporate all attributes regarding mercury, water, sealing and vibration described above. The quantity of CCFL lamps and length of lamp is dependent on the intended application. The cylindrical like member 230 may be incorporated in the part 204.

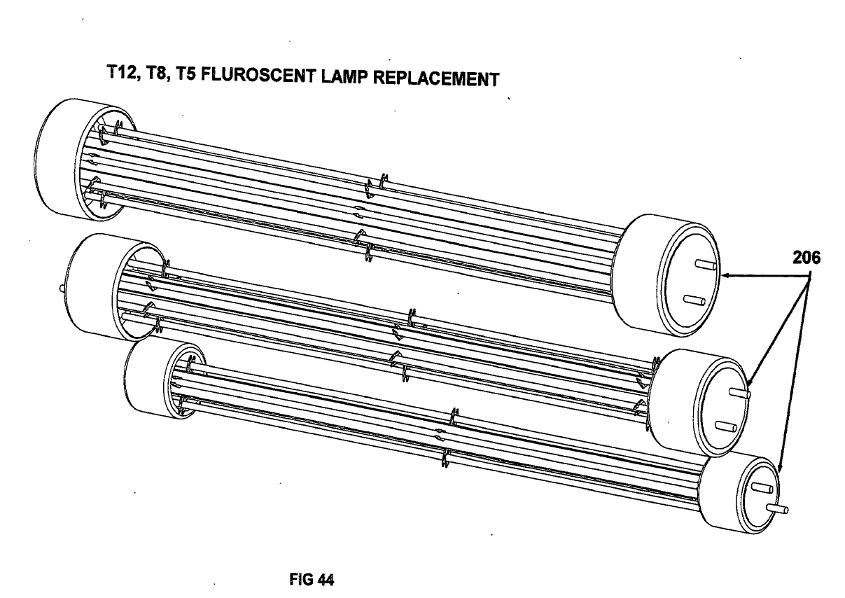

FIG. 44 shows various configurations for replacement of existing technology. Some may incorporate all attributes regarding mercury, water, sealing and vibration described above. Quantity of CCLF's and length of lamp is dependent on intended application. Pins 206 may fit standard fluorescent lamp fixtures. Member 230 may be incorporated in part 206.

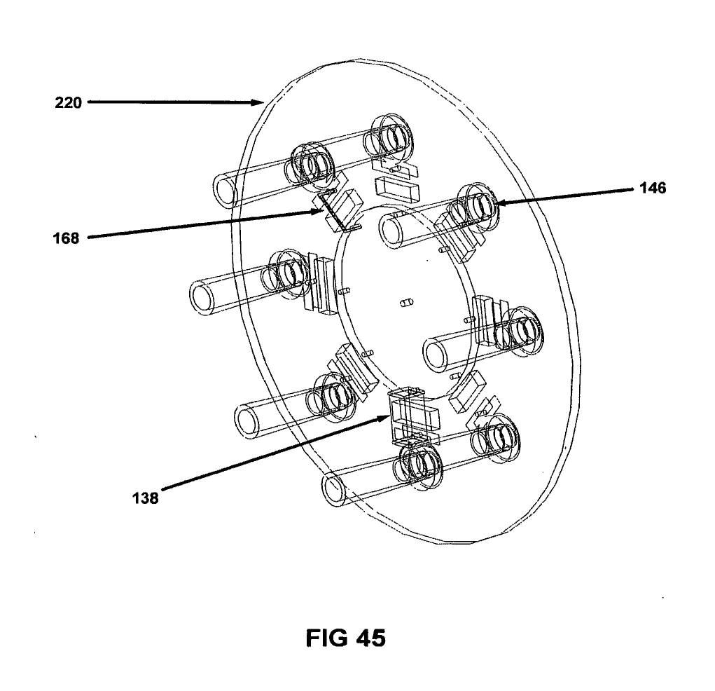

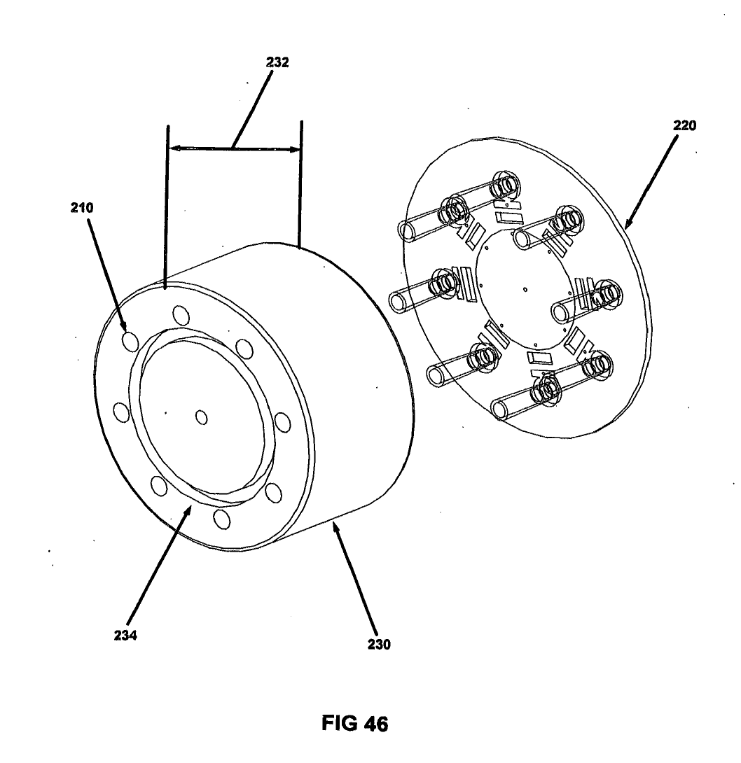

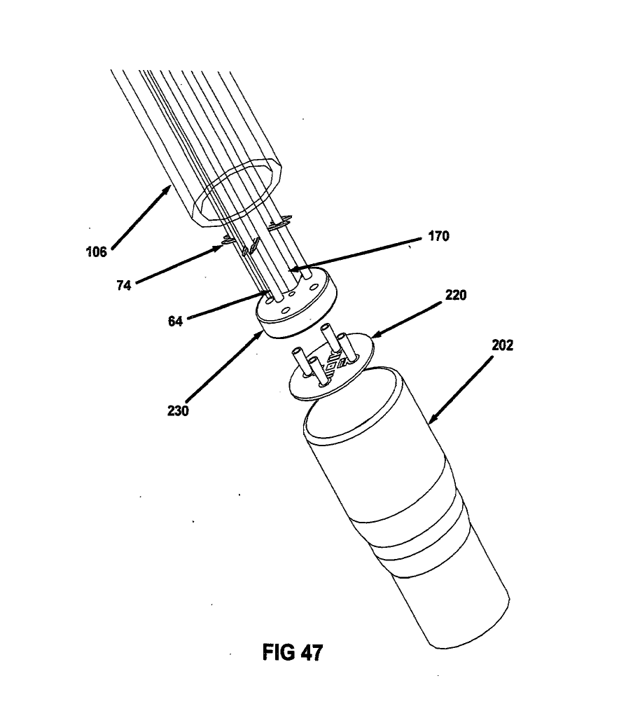

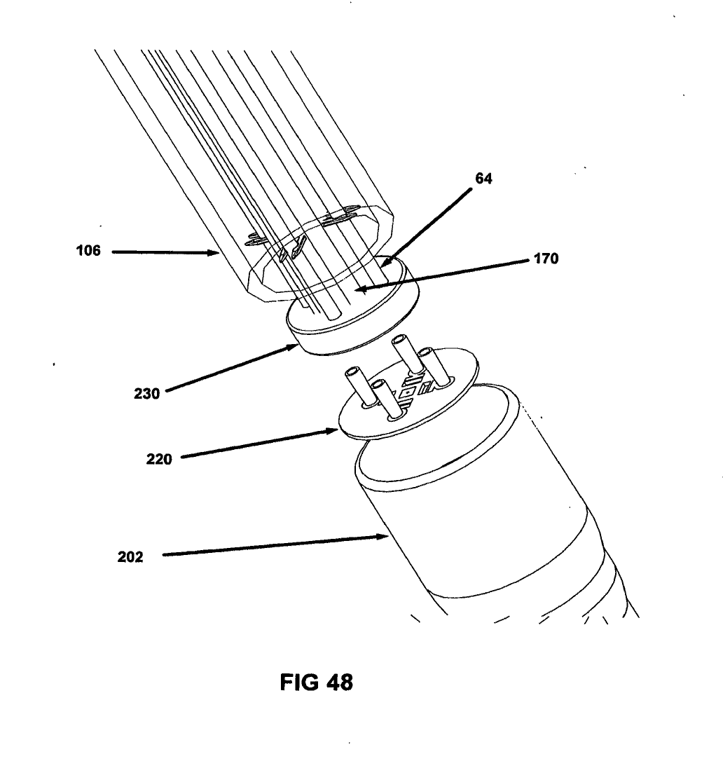

FIGS. 45 through 48 show incorporations/configurations of all components and associated attributes. The quantity and orientation of the various parts will be influenced by the number of CCFL's used, and the shape of member 220 may be less than 360 degrees, if partial round or some other configuration is desired as in a focused lamp. Member 230 may be used to stabilize the CCFL's. Assembly 200 may incorporate holders 74 and member 230. A groove 234 may be arranged at the end of light fixture 170 and may engage to center it longitudinally and radially. Dimension 232 may be such the member 230 is electrically isolated from the components attached to member 220. It is contemplated that the material of member 230 may be electrically nonconductive and may be optically transparent. Orifice 210 is arranged such that tube 62 may pass therethrough.

FIGS. 45 through 48 also show a complete assembly of base end 202 of CCFL 200. Light fixture 170 may incorporate reflectors 172, or it may be smooth, or optically shaped for a particular application, shown is basic round shape with lamps 64 mounted on an exterior. Another option may be partial round or other shape with lamps 64 mounted on an interior to form a focused light source. It should be noted that the interior structure of the lamp does not have to be configured to emit light 360 degrees it may be 180 degrees or such other number. Also, the reflector and assembly associated therewith may be concave or convex, lamps may be inside or have a curved reflective surface to focus/direct the emitted light in a particular direction.

The present invention has been described in an illustrative manner. It is to be understood that the terminology which has been used is intended to be in the nature of words of description rather than that of limitation.

Many modifications and variations of the present invention are possible in light of the above teachings. Therefore, within the scope of the appended claims, the present invention may be practiced otherwise than as specifically described.

What is claimed is:

1. An illumination device, comprising:
a tube;
a bead bonded to one end of said tube;
an electrode extending through said bead; and
a tapered coil spring arranged over said end of said tube, said tapered coil spring in contact with one end of said electrode.

2. The device of claim 1 wherein said electrode is arranged between and in contact with an outside surface of said tube and an inside surface of said spring.

3. The device of claim 1 wherein said spring having a lead extending from an end thereof.

4. The device of claim 3 wherein said spring having an open end at another end thereof.

5. The device of claim 1 wherein said spring having an open end at both ends thereof.

6. The device of claim 5 wherein one of said open ends having a larger or equal diameter with relation to a diameter of said other of said open ends.

7. The device of claim 1 wherein said electrode having a bend with a predetermined radius on one end thereof.

8. The device of claim 1 wherein said bead is made of a glass material.

9. The device of claim 1 further comprising a tube holder, said tube holder engaged with said tube.

10. The device of claim 9 wherein said tube holder having a first and second finger extending from a base thereof.

11. The device of claim 10 wherein said fingers having a lip extending from an outside surface thereof.

12. The device of claim 11 wherein said fingers having a recess area arranged on an inner surface thereof.

13. The device of claim 9 wherein said tube holder having a post extending from an end thereof.

14. The device of claim 13 wherein said post having a plurality of retaining fingers extending therefrom.

15. The device of claim 9 wherein the tube holder having a retainer ring arranged over a predetermined portion thereof.

16. An illumination device, comprising:
a base;
a′ light tube arranged within and rotatable with respect to said base;
a rotating member arranged within said base;
a first circuit board arranged within and rotatably fixed with respect to said rotating member; and
a second circuit board arranged within said light tube and in electrical contact with said first circuit board.

17. The device of claim 16 further comprising a cover secured to a top surface of said body.

18. The device of claim 16 wherein said base having a plurality of bearing surfaces, said bearing surfaces engage with and support an outer surface of said rotating member.

19. The device of claim 16 wherein said first circuit board having a plurality of spring loaded contacts, said spring loaded contacts are in contact with said second circuit board.

20. The device of claim 19 further comprising electrical circuitry which senses when said spring loaded contacts are in electrical contact with said second circuit board, said electrical circuitry ensures high voltage is not present at said spring loaded contacts unless a bulb and said light tube is arranged therein.

21. The device of claim 16 further comprising a seal arranged between said light tube and said base.

22. The device of claim 16 wherein said base having an extension extending from a portion thereof.

23. The device of claim 16 further comprising a second rotating member and a second light tube.

24. The device of claim 16 further comprising a containment plug arranged in one or both ends of said light tube.

25. The device of claim 24 wherein said plug is made of a material that bonds with or retains mercury or water vapor.

26. The device of claim 1 further comprising a containment plug arranged in one or both ends of said tube.

27. The device of claim 26 wherein said plug is made of a material that bonds with or retains mercury or water vapor.
